(19) United States
(12) Patent Application Publication
(10) Pub. No.: US 2025/0216742 A1
(43) Pub. Date: Jul. 3, 2025

(54) THIN FILM SYNCHRONOUSLY PUMPED OPTICAL PARAMETRIC OSCILLATORS

(71) Applicant: California Institute of Technology, Pasadena, CA (US)

(72) Inventors: Alireza Marandi, Pasadena, CA (US); Luis M. Ledezma, La Crescenta, CA (US); Arkadev Roy, Pasadena, CA (US); Ryoto Sekine, Pasadena, CA (US); Robert M. Gray, Pasadena, CA (US)

(73) Assignee: California Institute of Technology, Pasadena, CA (US)

(21) Appl. No.: 18/662,730

(22) Filed: May 13, 2024

Related U.S. Application Data
(60) Provisional application No. 63/532,648, filed on Aug. 14, 2023.
(60) Provisional application No. 63/466,188, filed on May 12, 2023.

(51) Int. Cl. G02F 1/39; G02F 1/35

(52) U.S. Cl. CPC G02F 1/39; G02F 1/3503; G02F 1/3548; G02F 2203/17

(57) ABSTRACT

A device including a photonic integrated circuit comprising one or more OPOs each comprising: an input configured to receive a pump wave comprising pulses or a frequency comb with a pump repetition rate, one or a plurality of nonlinear sections as part of a resonator or coupled to a resonator having a free spectral range, where at least one of the free spectral range or one of its harmonics is matched to the pump repetition rate or its harmonics, and one or a plurality of outputs configured to extract a portion of the waves generated by the OPO in response to the pump wave and/or the pump wave.

### CROSS-REFERENCE TO RELATED APPLICATIONS

This application claims the benefit under 35 U.S.C. Section 119 (e) of:
U.S. Provisional Application No. 63/466,188 filed May 12, 2023, by Alireza Marandi, Luis. M. Ledezma, Arkadev Roy, Ryoto Sekine, and Robert M. Gray, entitled “THIN FILM SYNCHRONOUSLY PUMPED OPTICAL PARAMETRIC OSCILLATORS,” (CIT-9012-P); and
U.S. Provisional Application No. 63/532,648 filed Aug. 14, 2023, by Ryoto Sekine, Robert M. Gray, and Alireza Marandi, entitled “ON-CHIP ULTRA SHORT PULSE SYNTHESIZER,” (CIT-9055-P);
both of which applications are incorporated by reference herein.

### FEDERALLY SPONSORED RESEARCH AND DEVELOPMENT

This invention was made with government support under Grant No(s). FA9550-20-1-0040 and FA9550-23-1-0755 awarded by the Air Force, Grant No(s). W911NF-18-1-0285 and W911NF-23-1-0048 awarded by the US Army, Grant No. D23AP00158 awarded by DARPA, and Grant No(s). ECCS1846273 and CCF1918549 awarded by the National Science Foundation. The government has certain rights in the invention.

### BACKGROUND OF THE INVENTION

Increasing efforts are focused on the realization of broadband frequency combs in nanophotonic platforms³⁻⁵ with applications including dual-comb spectroscopy⁶, optical communications⁷, optical frequency synthesis^{8,9}, and laser ranging¹⁰. However, the spectral coverage of integrated frequency comb sources remains far behind their table-top counterparts using high-pulse-energy lasers and discrete components, which have recently surpassed sixoctave spectra^{11,12}. Such frequency combs and short-pulse laser sources are valuable for applications such as ultrashort pulse synthesis¹³, attosecond science¹⁴, and bio-chemical sensing and imaging¹⁵⁻¹⁷ What is needed are improved methods of generating coherent pulsed sources and frequency combs. The present disclosure satisfies this need.

### SUMMARY OF THE INVENTION

The present disclosure describes on-chip optical parametric oscillators (OPOs) that are pumped by a frequency comb with a repetition rate synchronized to the OPO cavity roundtrip time. The on-chip OPOs are fabricated on a microchip based on a thin-film nonlinear optical material. The on-chip OPOs can generate frequency combs that can be tuned over broad and/or hard-to-access wavelength regions including, but not limited to, the visible, near-infrared, and mid-infrared wavelength ranges. The on-chip OPOs can also generate output frequency combs that cover a spectral range much broader than the pump frequency comb. The output frequency comb can cover one or more octaves of the electromagnetic spectrum. The on-chip OPOs can also be pumped by a frequency comb with repetition rate that is a harmonic of the OPO cavity roundtrip time. In this regime, the on-chip OPOs can support multiple pulses existing simultaneously inside the on chip OPO cavity. The on-chip OPOs can include actuators in the on-chip resonator for adjusting the repetition rate and carrier-envelope offset of the output frequency combs.

The present invention further discloses a multi-octave frequency comb generation using a optical parametric oscillator (OPO) in nanophotonic lithium niobate with only femtojoules of synch pumped pump energy. The energy-efficient and robust coherent spectral broadening occurs far above the oscillation threshold of the OPO and detuned from its linear synchrony with the pump. We show that the OPO can undergo a temporal self-cleaning mechanism by transitioning from an incoherent operation regime, which is typical for operation far above threshold, to an ultrabroad coherent regime, corresponding to the nonlinear phase compensating the OPO cavity detuning. Such a temporal self-cleaning mechanism and the subsequent multi-octave coherent spectrum has not been explored in previous OPO designs and features a relaxed requirement for the quality factor and relatively narrow spectral coverage of the cavity. We achieve orders of magnitude reduction in the energy requirement compared to the other techniques, confirm the coherence of the comb, and present a path towards more efficient and wider spectral broadening. Our results pave the way for ultrashort-pulse and ultrabroadband on-chip nonlinear photonic systems for numerous applications.

The present disclosure further discloses a pulse time-multiplexed Nanophotonic Optical Parametric Oscillator and the use of OPOs to support cavity quadratic solitons.

### BRIEF DESCRIPTION OF DRAWINGS

Referring now to the drawings in which like reference numbers represent corresponding parts throughout:

FIG. 1. Principle and design of the multi-octave nanophotonic OPO. a, Illustration of the sync-pumped OPO on thinfilm lithium niobate with key features highlighted. b, Microscope image of several devices when the one in the center is pumped at 1 μm. The chip glows green due to second harmonic generation (SHG). The top inset is a scanning electron microscope image of the spiral region and the bottom is a picture of the entire chip containing 16 OPOs. c. Illustration showcasing how short pump pulses can take advantage of near-zero-dispersion-engineered OPAs. The simulated gain profiles are shown in the top for a waveguide with 60 fs²/mm half-harmonic GVD and 26 fs/mm GVM and in the bottom for a near-zero-dispersion waveguide. The solid orange line marks the center wavelength of the pump and the orange shaded regions mark the 3-dB bandwidth (BW) of the 100-fs source. d, Depiction of the different regimes of operation of the OPO as a function of pump pulse energy, along with the roundtrip-to-roundtrip temporal output of the OPO in each regime.

FIG. 2. OPO characterization. a, Oscillation peaks of the OPO near-threshold as the pump repetition rate is modulated by a piezoelectric transducer (PZT) in the pump laser cavity at 600 Hz. b, Signal spectrum at 35 fJ of pump energy for three different roundtrip detunings and c, the corresponding OPO signal growth as a function of pump energy for different oscillation peaks and their slope efficiencies, η_{SL}. d, Output spectra, OPO oscillation peaks, and beatnote measurements from the OPO cavity at 54 fj, 109 fj, and 121 fj of pump. The OPO oscillation peaks (ii), (v), (viii) were taken under the same detector amplification settings. The RF beatnotes (iii), (vi), (ix) were taken between a free space and on-chip OPO that share the same pump, the rep rate of which is tuned over time.

FIG. 3. Simulation results showing different operation regimes of the nanophotonic OPO. a, Transition from (i) near-threshold coherent operation to (ii) incoherent operation and (iii) back to coherent operation when the pump energy is increased. The roundtrip temporal evolution (i-iii) and output spectra (iv-vi) are shown for three different pump intensities using experimental parameters and at a cavity detuning of −10.5 fs. b, A three-octave coherent OPO. The same experimental parameters are used except that the last one mm of the PPLN was replaced with a chirped poling period. The pump pulse energy was at 250 fJ.

FIG. 4. Performance comparison of (a), integrated spectral broadening, and (b), frequency comb sync-pumped OPOs. a, Wavelength coverage and pump pulse energies of integrated frequency comb spectral broadening schemes. The arrows indicate the pump wavelength. b, Comb repetition rates and pump threshold energies of sync-pumped OPOs. The marker shapes denote the different cavity and nonlinear (NL) element compositions for each OPO, the categories being free space, fiber, integrated and bulk, fiber, nanophotonic respectively. In both figures, the top legend denotes the material of the nonlinear element. Abbreviations, TFLN: thin-film lithium niobate, OP: orientation patterned, MF: microstructured fiber, HNLF: highly nonlinear fiber.

FIG. 5. Key OPO design parameters as a function of waveguide geometry. a, Parameters for tuning spatiotemporal confinement of pulses propagating through our nanophotonic waveguides. An example fundamental TE mode at 1 μm is shown in the core of the waveguide. b, Dispersion profile c, Phase-matched poling period, and d, Optimal sync-pumping cavity length as a function of waveguide top width and etch depth variations. The actual measured dimensions of our fabricated device are indicated by the cross.

FIG. 6. Additional OPO parameters given the waveguide geometry shown in FIG. S1. a, Effective index of the waveguide b, Second harmonic microscope image of the periodic poling pre-waveguide patterning, and c, Simulated propagation loss as a function of bend radius for different signal wavelengths. The dotted blue line is at 77 μm, the minimum bend radius employed when designing the OPO cavity.

FIG. 7. OPO coupler design. a, Definition of the input/output coupler and b, an illustration of the output coupler adiabatic design. Here, the widths and gaps refer to those at the top of the waveguide. c, The waveguide fundamental TE modes at 1 μm and 2 μm. d, The simulated coupler response using the fabricated waveguide geometry. e, Comparing the theoretical coupler behavior to measured spectra at 380 fj of pump for otherwise identical devices with and without couplers.

FIG. 8. Experimental Setup. Abbreviations, PS: phase sensitive, MLL: mode locked laser, LP: long pass, BS: beam splitter.

FIG. 9. Extended Measurements to ˜20× above threshold. a Output spectra from the OPO cavity up to 380 fJ of pump pulse energy. b For the same energies, the top panels show the OPO oscillation peaks as the pump rep rate is scanned by a PZT. The bottom panels show the RF beatnote between a free space and on-chip OPO that share the same pump, the rep rate of which is tuned over time at 63.58 mHz.

FIG. 10. Absorption features of atmospheric molecules compared to the OPO spectra measured at 380 fj of pump. The spectral lines were taken from the HITRAN database[1].

FIG. 11. Simulated mode crossings compared to measured straight waveguide spectra. a, Simulated modes at the periodically poled region of the chip. The mode crossings experienced by the fundamental TE mode are marked as M1 and M2. Close-ups of these are shown in b and c respectively. d, The measured power spectral density of a periodically poled nanophotonic waveguide with no OPO cavity as a function of pump pulse energy. The locations of M1 (680 nm) and M2 (1135 nm) are indicated by arrows.

FIG. 12. OPO beatnote measurement. a, Experimental setup. b, Illustration of the two f_{CEO} states possible for the OPO comb depending on the detuning peak, l, being even or odd. c, (i) RF beatnote and (ii) spectral overlap, showing interference fringes (blue) as the relative output delay between the OPOs is scanned in the case where they share an f_{CEO} in the temporal self-cleaning regime.

FIG. 13. OPO beatnote locked in the Temporal Self-Cleaning Regime. The pump here is at 121 fJ, and the pump rep rate is locked to the OPO peak structures seen in the OPO oscillation peaks in FIG. 2d (viii) of the main text. The top panel shows the fᵣₑₚ/2 beatnote at a representative time, and the bottom panel shows the beatnote persist over time. The dither signals of the free-space and on-chip OPO cavity locks cause the two sets of side fringes to the main fᵣₑₚ/2 beatnote.

FIG. 14. SHG beatnote measurement. a, Experimental setup. b, Spectral overlap between the chip SHG outputs and the PCF. Sample beatnotes measured at c, 380 fJ, d, 109 fJ, and e, 54 fJ with the different colors corresponding to different pump f_{CEO}. Abbreviations, SP: short pass, PCF: photonic crystal fiber (Menlo Systems), HWP: half wave plate.

FIG. 15. a, Extended regimes of operation of the nanophotonic OPO and b, OPO resonances labeled in terms of detuning peak (l), and cavity roundtrip detuning (ΔT_{RT}).

FIG. 16. OPO Characterization: l=2, ϕ_{CEO}=0.

FIG. 17. OPO Characterization: l=0, ϕ_{CEO}=0.

FIG. 18. OPO Characterization: l=−2, ϕ_{CEO}=0.

FIG. 19. OPO Characterization: l=3, ϕ_{CEO}=0.

FIG. 20. OPO Characterization: l=1, ϕ_{CEO}=0.

FIG. 21. OPO Characterization: l=−1, ϕ_{CEO}=0.

FIG. 22. OPO Characterization: l=−3, ϕ_{CEO}=0.

FIG. 23. Further characterization of the coherence of regime (iii) for l=−3, ϕ_{CEO}=0. a, g⁽¹⁾ coherence as a function of wavelength, PSD, and roundtrip spectra, where points with simulated coherence greater than 0.6 are denoted by a light green dot, with the rest colored in pink. For the roundtrip phase plot, points where the difference in phase compared to the prior roundtrip is smaller than π/6 are plotted in green with the other points marked in pink. b, Simulated comb lines at the output. The 2-μm, 1-μm, 69-nm, and 500-nm combs correspond to the half-harmonic, pump, sum-frequency generation of the pump and half-harmonic, and second harmonic of the pump respectively.

FIG. 24. OPO Characterization: Peak 2, ϕ_{CEO}=π.

FIG. 25. OPO Characterization: Peak 0, ϕ_{CEO}=π.

FIG. 26 OPO Characterization: Peak −2, ϕ_{CEO}=π.

FIG. 27 Intensity and phase evolution inside the crystal for the half-harmonic (top) and pump (bottom) of regime (iii) for l=−3, ϕ_{ceo}=0. For a (ii) and b (ii), the phase of regions with intensity greater than ˜0.2 W are encircled, and phases of locations with lower intensities are made more transparent.

FIG. 28. Temporal output of the two-octave combs at different detunings. In each case, the pink line showing the 3 dB bandwidth of the central feature is ˜4.2 fs. Here, ϕ_{CEO}=0.

FIG. 29 Three Octave Comb Characterization at l=3, ϕ_{CEO}=0. Coherence and normalized output spectrum of a simulated OPO with additional duty cycle variations in the poling period to yield a three-octave coherent frequency comb with 248 fJ of pump.

FIG. 30. Nanophotonic Cavity Quadratic Soliton. (a) Concept of these solitons and the resulting pulse compression in synchornously pumped OPOs. (b) Dispersion parameters of a nanophotonic periodically poled lithium niobate (PPLN) OPO as a function of waveguide top width and etch depth. A PPLN length of 5 mm and resonator length of 11 mm was used.

FIG. 31: Ultra-widely tunable frequency combs from nanophotonic parametric oscillators. a) Schematic of a doubly resonant optical parametric oscillator fabricated on an X-cut thin-film lithium niobate consisting of a periodically poled region for efficient parametric nonlinear interaction. The waveguides (dimensions: width of 2.5 μm, etch depth of 250 nm) support guided modes in the mid-infrared corresponding to the idler wave. b) Quasi-phase matched parametric gain tuning from visible-to-mid-IR. Phase-matching curves leading to tunable mid-infrared idler emission enabled by optical parametric oscillator devices with slightly different poling periods (Λ) integrated on the same chip. The same chip is capable of producing tunable visible frequency combs thanks to the sum frequency generation (SFG) process between the pump with the signal and idler waves. Other accompanying up-conversion processes include the second-harmonic (SH) of the signal and the idler. Some second-harmonic phase-matching curves have been omitted for better clarity. c) The emission from the chip overlaps with strong molecular absorption lines in the mid-infrared covering a spectral window important for molecular spectroscopy. The spectral coverage in the visible includes atomic transition wavelengths corresponding to commonly used trapped ions/neutral atoms/color centers.

FIG. 32: Near-IR to mid-IR frequency combs from nanophotonic OPOs on a single chip. a) Schematic of the experimental setup used to pump and measure the synchronously pumped optical parametric oscillator chip. The image of the OPO chip is shown alongside, b) Experimental measurements of the spectral and temporal characteristics (intensity auto-correlation trace) of the electro-optic pulsed pump showing a pulse-width of ˜1 ps, c) Broadband infrared spectral coverage of the OPO chip showing the signal and the idler spectrum as its operation is tuned from degeneracy to far non-degeneracy. Separate colors represent outputs from different OPO devices on the same chip with distinct poling periods. Zoomed-in versions display the comb line structure.

FIG. 33: Characteristics of the frequency comb generated from the synchronously pumped on-chip OPOs. a) Resonance peak structure obtained by sweeping the pump central wavelength which is typical of doubly-resonant OPO operation. A zoomed-in view of a single peak is shown in the inset, b) Range of existence of the synchronously pumped OPO for a fixed pump power as the pump repetition rate is varied, c) Fine tuning of the OPO frequency comb output enabled by tuning the pump central wavelength, d) Spectral broadening of the OPO operating at degeneracy corresponding to a sub-picosecond transform-limited duration of ˜400 fs, e) Verification of the coherence of the OPO output as evident from the existence of interference fringes (see inset) in the electric-field cross-correlation trace, f) The close agreement between the spectra obtained from an optical spectrum analyzer measurement and that obtained by Fourier transforming the field cross-correlation corroborates the coherence of the OPO output.

FIG. 34: Visible frequency comb generation from the integrated optical parametric oscillator chip. a) The complete emission spectrum of an OPO (Spectra obtained from different optical spectrum analyzers/spectrometers are stitched together). Apart from the emission of the signal and the idler waves, the OPO also produces output in the visible spectra owing to the auxiliary nonlinear processes namely the second-harmonic generation (SHG) and the sum-frequency generation (SFG). b) Optical microscope image capturing the visible light emission from various regions of the periodically poled section of the OPO device, c) Tunable visible frequency comb generation from the integrated OPO chip, where different colors indicate spectra obtained from OPOs with distinct poling periods.

FIG. 35: SEM image of the adiabatic coupler region. a) The waveguides (dimensions: width of 2.5 μm, etch depth of 250 nm) support guided-modes in the mid-infrared corresponding to the idler wave, the electric field distribution (fundamental TE mode) of which is shown. b) The SEM image of the fabricated device showing the coupler region.

FIG. 36: Visible frequency comb generation. a), b), c) Experimentally obtained tunable visible frequency comb (sum frequency generation between the signal and the pump) via pump frequency tuning.

FIG. 37: Second harmonic generation of the signal frequency comb. a) Phase matching curves for different poling periods corresponding to the second-harmonic generation of the signal frequency comb. b) Coarse tuning of the second harmonic of the signal frequency combs as obtained from the OPO chip. c) Fine tuning of the second harmonic of the signal frequency combs as obtained from a single OPO via pump wavelength tuning.

FIG. 38: Coupler response and OPO conversion efficiency. a) Signal conversion efficiency as a function of on-chip pump power. The experimental data fit well with the

FIG. 39: Measurement data for average power per comb line. Mid-infrared frequency comb (Idler frequency comb) spectrum obtained using optical spectrum analyzer that is used for the calculation of power per comb line. Optical spectrum analyzer settings: Resolution bandwidth 1 nm, sampling interval 0.05 nm, and frequency comb repetition rate ˜19 GHz.

FIG. 40: Electro-optic comb generation setup. a) Schematic of the setup for electro-optic comb generation that is used for the sync-pumping of the OPO. Arbitrary Waveform Generator (AWG), Semiconductor Optical Amplifier (SOA), Intensity Modulator (IM), Phase Modulator (PM), Ytterbium Doped Fiber Amplifier (YDFA), Optical Spectrum Analyzer (OSA). b, c, d) Simulated waveforms in the time and frequency domain at different stages of the pump preparation setup.

FIG. 41: Quasi sync-pump OPO setup. a) Schematic of the setup for electrooptic comb generation that is used for the sync-pumping of the OPO in the quasimode of operation. Arbitrary Waveform Generator (AWG), Semiconductor Optical Amplifier (SOA), Intensity Modulator (IM), Phase Modulator (PM), Ytterbium Doped Fiber Amplifier (YDFA), Optical Spectrum Analyzer (OSA). b) Measured time domain trace of

FIG. 42: Schematic of the setup for estimating cavity FSR. Arbitrary Waveform Generator (AWG), Semiconductor Optical Amplifier (SOA), Intensity Modulator (IM), Ytterbium Doped Fiber Amplifier (YDFA).

FIG. 43: Spectral broadening and associated pulse compression in the degenerate regime of OPO operation. a) Experimentally obtained spectrum plotted in the frequency axis after spectral translation showing the effect of spectral broadening in the signal compared to the pump. b) Spectrum obtained from the numerical simulation showing the spectral broadening effect (assuming a sechshaped pump pulse). c) Pump and signal pulses in the time domain as obtained from the numerical simulation. d) The numerically obtained signal pulse when fitted with a sech shaped pulse denotes a pulse compression by a factor of approximately 2. e) The normalized roundtrip evolution of the signal pulses that are initiated from the vacuum field till it reaches the steady state.

FIG. 44: [Coherence verification setup. a) Schematic of the setup used to verify the coherence of the OPO output. b) Measured RF beat-note frequency corresponding to the applied repetition rate of the sync-pumped OPO.

FIG. 45: Envisioned full integration of an universal frequency comb source. a) Illustration of a lithium niobate nanophotonics-based near-IR picosecond pump source consisting of a cascade of intensity and phase modulators followed by a dechirping spiral waveguide. b) Illustration of a lithium niobate OPO chip consisting of an array of OPOs dedicated to cover different spectral regions which can be programmatically pumped with the help of the MZI routing circuit preceding it.

FIG. 46: Temperature tuning of the quasi-phase-matching. Temperature tuning of the quasi-phase-matching obtained from simulation for the a) signal and the idler waves and b) their corresponding up-conversion with the pump leading to visible frequency combs. The pump wavelength is kept fixed at 1060 nm.

FIG. 47. Experimental setup for measuring the 40-pulse time-multiplexed optical parametric oscillator. (a) An EO comb with a 10-GHz repetition rate is used to pump the on-chip spiral OPO cavity with a 250-MHz free-spectral range, leading to simultaneous oscillation of 40 independent signal pulses. The pump is characterized by its spectrum (b) and intensity autocorrelation (c). (d) Optical microscope image of the fabricated on-chip spiral cavity.

FIG. 48. Experimental result showing interference behaviors of the OPO output in the degenerate (a) and non-degenerate (b) cases. Subfigure (i) shows the spectrum for both. (ii) Sample of the interference time trace data as compared to the reference, measured at the input of the interferometer. (iii) Histogram of peak value measured in each time bin, showing the expected discretization when the OPO is degenerate. (iv) For the degenerate case, comparison with the theoretical probability mass function of the output levels.

FIG. 49. Schematic of pump sub-circuits and additional components.

FIG. 50. Method of making a device.

FIG. 51. Method of operating a device.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

Integrated sources of short-pulse frequency combs typically generate picojoules or femtojoules of pulse energies^{2,4,18-20} and their spectral coverage barely reaches an octave^{21,22}. This has necessitated further spectral broadening stages for many applications, which so far have been realized strictly using table-top systems with discrete amplifiers and components^{1,8,23}. A femtojoule-level multi-octave coherent spectral broadening mechanism has so far been beyond the reach of current photonic technologies, and hence, a path towards a fully integrated multi-octave frequency comb has remained elusive.

Substantial spectral broadening is typically achieved by passing femtosecond or picosecond pulses with^{0.1-10} nJ of energy through waveguides, crystals or fibers with quadratic (χ⁽²⁾) or Kerr (χ⁽³⁾) nonlinearity with various designs^{1,24-28}. Among these schemes, waveguides with quadratic nonlinearity are becoming increasingly more efficient, especially because of the recent progress on quasi-phase matching and dispersion engineering and show superior performances over their cubic counterparts. However, to reach an octave of coherent spectrum and beyond they still need 10's of picojoules of energy²⁹, which is far beyond the current capability of integrated frequency comb sources.

Resonant enhancement of spectral broadening is expected to improve the energy requirements. However, such experiments have so far remained below an octave^{23,30,31}. This is mainly because of the overly constrained dispersion requirements of cubic coherent spectral broadening schemes especially when combined with high-Q requirements. In fact, even linear components in nanophotonics with multi-octave spectral response are still challenging to design and realize³². In contrast, quadratic nonlinearity not only leads to lower energy requirements in single-pass configurations, but it also offers a wider range of nonlinear processes for ultrawide coherent spectral broadening resulting from nonlinear interactions of distant portions of the spectrum^{11,12}. However, a proper resonator design is necessary to enable an operation regime where a sequence of quadratic nonlinear processes can yield coherent spectral broadening towards multi-octave operation.

path towards such a multi-octave nonlinear resonator is based on synchronously (sync-) pumped degenerate OPOs, which so far have been successfully used in bulk optics for efficient phase-locked downconversion via half-harmonic generation of broadband frequency combs^{15,33-35}. Recent studies by one or more of the inventors indicated the potential of sync-pumped OPOs for extreme pulse shortening and spectral broadening while preserving the coherence properties of the pump³⁶. However, lack of dispersion engineering in bulk nonlinear crystals, low parametric gain bandwidths, and multi-picojoule thresholds have put limitations on their applicability for compact and ultrabroadband frequency comb applications. Recent developments of dispersion-engineered optical parametric amplifiers (OPAs)³⁷ and narrowband sync-pumped OPOs³⁸ in lithium niobate nanophotonics promise a path towards overcoming these limitations and accessing a new regime of ultrabroadband ultra-low-energy nonlinear optics that has not been accessible before.

### First Embodiment: Multi-Octave Frequency Comb

### 1. Device Structure

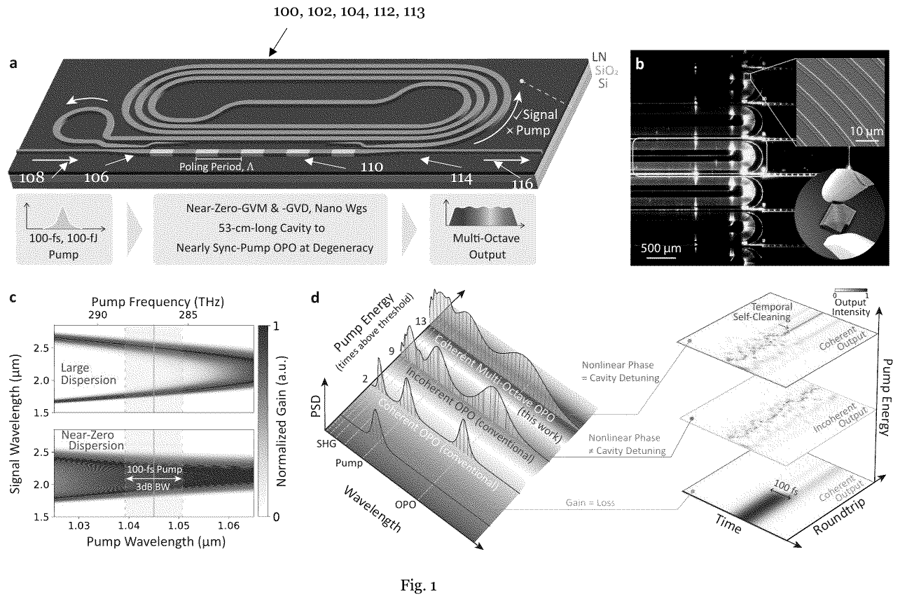

FIG. 1a illustrates the design of the on-chip syncpumped OPO, with the fabricated device shown in FIG. 1b. The input/output couplers are designed to allow resonance only around the half-harmonic of the pump (see supplementary information section), and the cavity is designed to be minimally dispersive for these wavelengths. To phase and frequency lock the OPO, the OPO is nearly sync-pumped at degeneracy, requiring a cavity round-trip time of 4 ns for a pump comb with a 250 MHz repetition rate. With the effective index of our nanophotonic lithium niobate waveguides (wgs), this amounts to a 53-cm-long-cavity.

To achieve the ultra-high, ultra-broad, phase-sensitive gain at fJ pump pulse energies that enables coherent broadband comb generation, the OPO includes a 10.8 mm OPA with proper dispersion engineering and quasi phase matching (QPM). Specifically, we target minimizing the group velocity dispersion (GVD) of the pump and signal, as well as the group velocity mismatch (GVM) between the pump and signal³⁷. FIG. 1d illustrates the large gain bandwidth that can be accessed when coupling a 100-fs pump to a near-zero dispersion engineered waveguide, as opposed to one with large dispersion that is favored for broadly tunable OPOs^{38,39}. The designs for the poling period, cavity length, and couplers for syncpumped operation can be found in the Supplementary, Section.

FIG. 1d illustrates the different regimes of operation of this nanophotonic OPO. At low pump pulse energies, the OPO goes above threshold when the gain overcomes the loss inside the cavity. This is conventionally the regime where OPOs are operated to yield coherent outputs phase-locked to the pump³⁴. At higher pump pulse energies a degenerate OPO is known to transition to an unstable operation regime where the phase-locked operation diminishes^{40,41}. Here however, we find that far above threshold, the OPO can undergo a transition to the phase-locked regime as a result of the nonlinear phase being compensated by the cavity. This is emphasized in the accompanying time domain plots as a temporal self-cleaning mechanism, where after a finite number of roundtrips the output pulse intensity is seen to stabilize with ultrashort features in the multi-octave case. This emergence of coherence and ultra-short pulse formation is reminiscent of condensation and thermalization occurring in other nonlinear multimode systems^{42,43}

### 2. Experimental Results

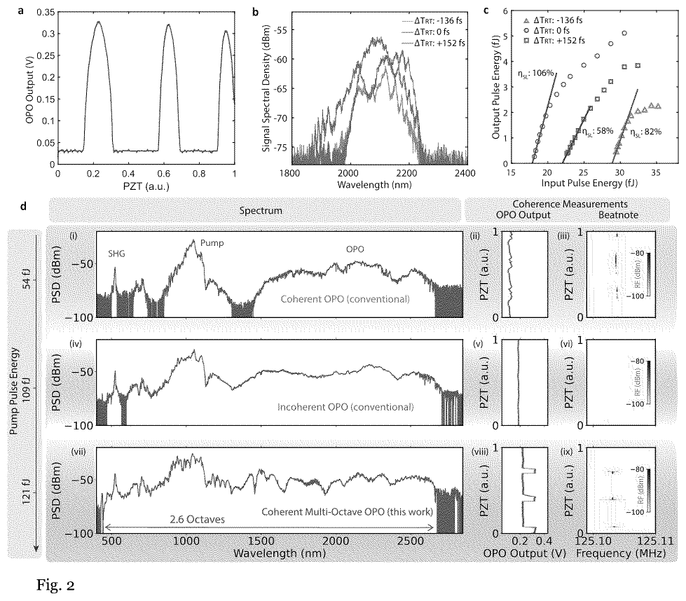

In FIG. 2a-c, we show the near-threshold performance of the nanophotonic OPO. Scanning the repetition rate of the pump by 600 Hz, we observed the oscillation peaks of the OPO as depicted in FIG. 2a. These peaks are characteristic of doubly-resonant operation³⁴. We actively locked the pump repetition rate to the center of each of these peaks, and the near-threshold signal spectra of three such peaks at distinct detunigs between the pump repetition period and cavity round-trip time, ΔT^{RT}, are shown in FIG. 2b. In FIG. 2c we show the measured input-output pulse energy growth of these same peaks. We extrapolated the threshold and slope efficiencies, η_{SL}, and defined the peak with the lowest threshold as the zero cavity detuned state. For this peak we estimated an OPO threshold of ˜18 fJ.

In FIG. 2d, we show three characteristic output spectra of the OPO. At 54 fJ of pump we observed conventional OPO behavior. The pump, half-harmonic and second harmonic are all spectrally broadened, and there was noticeable sum frequency generation (SFG) between the pump and half harmonic. At 109 fJ of pump, we observed continuous spectra from 600 nm to 2710 nm, and at 121 fJ we observed continuous spectra from 443 nm to 2676 nm. The dip at 2.8 μm is associated with the OH absorption peak in the LN and/or the buffer layer^{39,44}, and kinks near 680 nm and 1135 nm are due to mode crossings (see Supplementary Section). It is also worth noting that the spectra at 121 fJ has some distinctive signatures on the long wavelength side of the spectrum that are absent in the 109 fJ pumped cases.

To characterize the coherence of the OPO at these pump pulse energies, we interfered the chip output with that of a free-space OPO pumped by the same laser using a filter centered around 2.1 μm. When operated in a coherent regime, a degenerate OPO above threshold can have two possible CEO frequencies which differ by half of the pump repetition rate, fᵣₑₚ/2, depending on the oscillation peak³⁴. When the on-chip OPO has a different CEO from the free-space OPO, upon spatially and temporally overlapping their outputs, beatnotes at fᵣₑₚ/2 should be observed. For the coherence measurements in FIG. 2d, scanned the repetition rate of the pump over time. At 54 fJ of pump, FIG. 2d (ii) shows that the on-chip OPO exhibited features at certain detunings, which are reflected by the fᵣₑₚ/2 beatnotes between the OPOs in FIG. 2d (iii). The lack of these signatures both in the OPO power and beatnotes at 109 fJ of pump, indicate that the on-chip OPO has transitioned from a coherent to incoherent regime. At 121 fJ however, the OPO peak structures and RF beatnote reappeared, signifying the reemergence of a coherent operating regime.

The coherence of the second-harmonic portions of these spectra were confirmed using a spectrally broadened output of the pump by a photonic crystal fiber. We interfered this broadened pump with the second-harmonic portion of the on-chip OPO and observe beatnotes of the resultant carrier-envelope offset frequency, f_{CEO}, along with the pump repetition rate at 250 MHz for all of the pump pulse energies in FIG. 2d, irrespective of the detuning (see Supplementary Section). In particular, at 121 fJ of pump, because both the halfharmonic and second harmonic combs are coherent with respect to the pump and all frequency portions of our spectrum are generated through parametric processes of these three combs²⁹, we concluded that the continuous 2.6 octave spectrum in FIG. 2d is coherent. We locked the repetition rate of the pump to keep the OPO oscillating in this state, and in Supplementary Section IIE we show the beatnote signal being maintained over time.

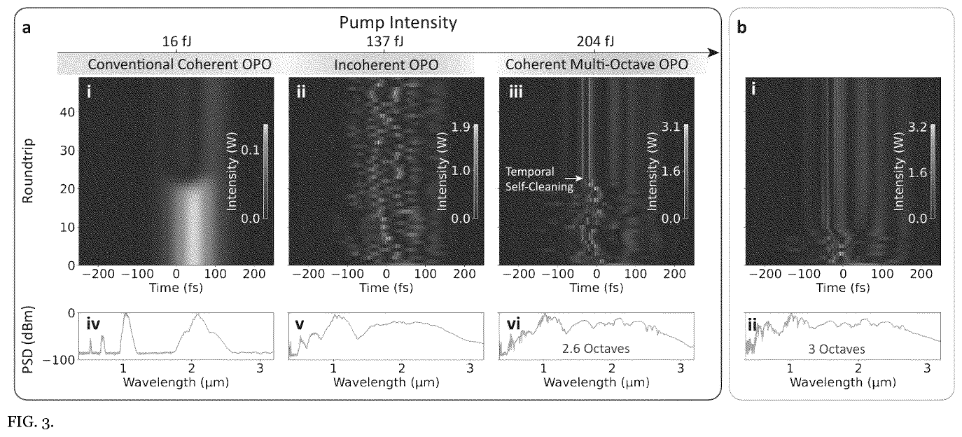

The dynamics of this OPO far above threshold and how coherence can be established over such a broad spectrum using the numerical simulations. To capture the multi-octave nonlinear interactions occurring in the OPO, we model the electric field in the nanophotonic cavity as a single envelope in frequency domain which is evolved using the split-step Fourier method for propagation in the PPLN region and a linear filter for the cavity feedback (see Supplementary Section). In FIG. 3a, we show how this captures distinct regimes of operation when using parameters matching that of the experiment. At 16 fJ the OPO goes above threshold and stabilizes after ˜20 roundtrips. At this point, all the frequency translated components (OPO, SHG, SFG of the pump and OPO) are coherent with respect to the pump and they remain unchanged from roundtrip to roundtrip. As the pump pulse energy is increased, fewer roundtrips are required for the OPO to form, and at 137 fJ of pump (˜9× above threshold) we see that the OPO output is incoherent.

At roughly 204 fJ of pump (˜13× above threshold), however, the the half-harmonic is seen to acquire a π phase shift through the nonlinear interaction with the pump in each single-pass through the PPLN region. This can be compensated by detuning the cavity by an odd number of OPO peaks, or by adding a constant phase offset of π between the pump and cavity, corresponding to the carrier-envelope offset phase, ϕ_{CEO}, of the pump (see Supplementary Section IIIB). The former case is shown in FIG. 3a (iii) and shows a two octave coherent continuous comb that stabilizes after roughly twenty roundtrips with temporal features as short as 4 fs (see Supplementary Section IIIC). The output spectrum is also very similar to the detuned 121 fJ experimental result of FIG. 2d.

Simulations are used to further investigate how to extend the coherent operation of the OPO to even broader spectra. By replacing the last one mm of the PPLN region with a chirped poling period for efficient second harmonic and sum-frequency generation, we achieve a coherent three octave continuous frequency comb with ˜250 fJ of pump energy as shown in FIG. 3b.

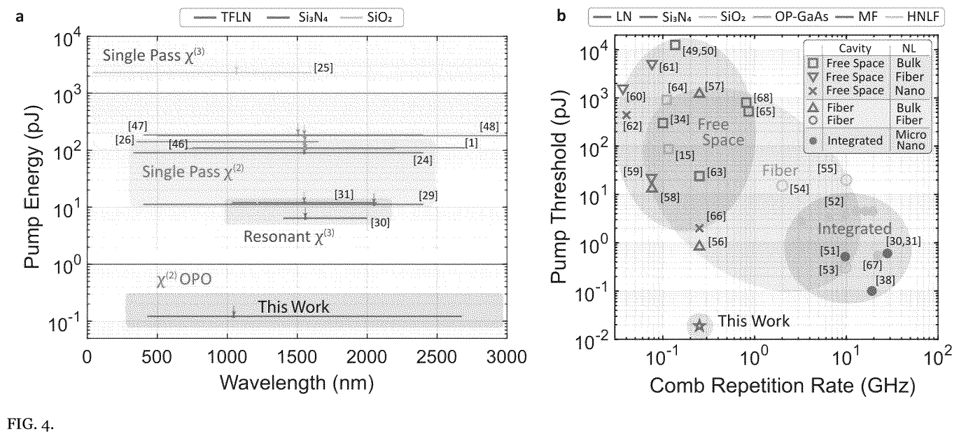

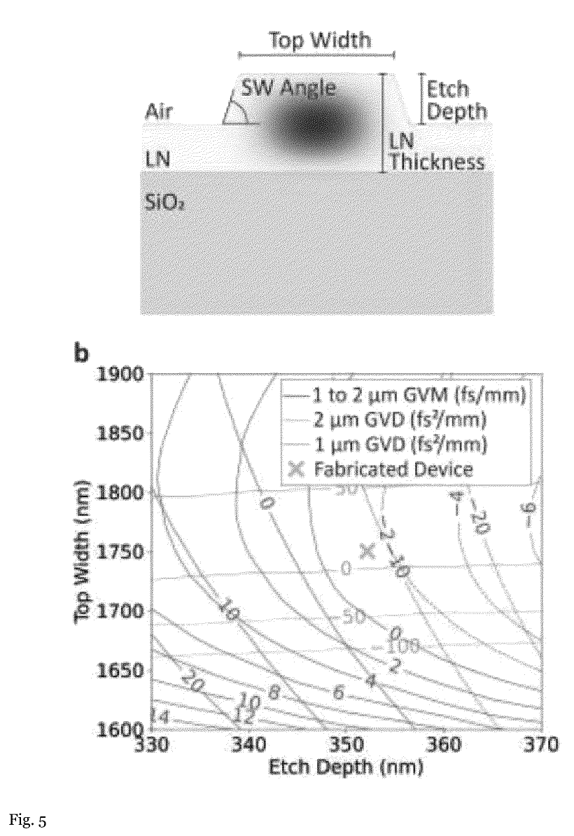

In FIG. 4 we compare our results with other integrated spectral broadening schemes and sync-pumped OPOs. The figure highlights how our nanophotonic OPO design and its operation regime enable orders-of-magnitude improvement in the energy efficiency of coherent spectral broadening. Our work represents the lowest threshold sync-pumped OPO which is enabled by its near-zero dispersion design. This ultralow-threshold operation enabled accessing a previously unexplored operation regime of the OPO far above threshold, where ultrabroad coherent spectral broadening is established as a consequence of the balance between cavity detuning and nonlinear phase shift.

In summary, we have experimentally demonstrated a nearly sync-pumped nanophotonic OPO operating in the near zero-GVM, zero-GVD, fs-pumped, high-gain lowfinesse regime resulting in an ultra-broadband coherent output with only ˜121 fJ of energy. The 2.6 octave frequency comb enables unprecedented opportunities for on-chip applications including wavelength division multiplexing⁷, dual-comb spectroscopy⁴⁵, and frequency synthesis⁵. We show the OPO transitions from an incoherent to coherent operation regime and demonstrate a path towards much broader frequency comb sources in the femtojoule regime.

### 3. Methods of Fabricating and Characterization

Device fabrication. Our device was fabricated on 700-nm-thick X-cut MgO-doped thin-film lithium niobate on a SiO₂/Si substrate (NANOLN). Following the procedure in³⁷, Cr/Au poling electrodes were patterned with 16 fixed poling periods ranging from 4.955-5.18 μm using lift-off and and apply a voltage to periodically flip the ferroelectric domains. Upon poling, the electrodes were removed the waveguides were etched using Ar-milling and Hyrdogen Silsesquioxane (HSQ) as the etch mask. Finally, the waveguide facets were mechanically polished to allow for butt coupling. Each OPO has a footprint of 0.5 mm×13 mm.

Optical measurements. The measurements were performed using a Menlo Orange HP10 Yb mode-locked laser (MLL) centered at 1045 nm. It outputted 100-fs-long pulses at 250 MHz with a ±1 MHz tuning range. Light was coupled to and from the chip using Newport 50102-02 reflective objectives, chosen for their minimal chromatic aberration. All of the results described in this embodiment were performed on a device with 5.075 μm poling period at 26° C., regulated by a thermoelectric cooler (TEC). The lowest OPO threshold was obtained from a pump repetition rate of 250.1775 MHz, which we defined as the zero detuned state. This device had a total throughput loss of 43.4 dB, and following the methodology in³⁷, we measured the input and output coupling losses to be 35.7 dB and 7.7 dB respectively. For the results in FIG. 3d, the spectra were collected by two different optical spectrum analyzers (OSA), specifically a Yokogawa AQ6374 (350-1750 nm) and AQ6376 (1500-3400 nm). The OSAs were operated with High3 sensitivity except for the case of 121 fJ of pump, where High2 was used. The RF spectra in FIG. 2d were collected by an electronic spectrum analyzer (Rhode & Schwarz FSW) using an InGaAs high speed photodiode (DSC2-40S). The SHG beatnotes were taken using a high-speed silicon avalanche photodiode (Menlo Systems APD210).

Numerical simulations. We use commercial software (Lumerical Inc.) to solve for the waveguide modes shown in Sections I and II of the Supplementary that allowed us to dispersion engineer and quasi-phase-match our device. For the nonlinear optical simulation, we solve an analytical nonlinear envelope equation as described in Section III of the Supplementary Information. The simulations were performed with no constant phase offset between the pump and cavity unless specifically mentioned otherwise. This parameter effectively acts as a carrier-envelope offset phase of the pump, PCEO. As the simulations were performed with a time window of 1.7 ps, it should be mentioned that a large portion of the short wavelength side of the spectrum walked out of the time window of our simulation. For example, the simulated GVM between our simulation reference frame at the half-harmonic signal wavelength of 2090 nm and the second harmonic of the pump at 522 nm is 721 fs/mm. As a result, the upconverted portions of the spectrum in simulation tend to be smaller than what was measured experimentally. In these simulations we have only incorporated the effects of χ⁽²⁾ nonlinearity and have not considered the effects of χ⁽³⁾. Especially given the low pulse energies and lowfinesse nature of our cavity, we believe this to be a good approximation, yet it could be one additional reason for small discrepancies between experiment and simulation.

### References for the First Embodiment

The following references are incorporated by reference herein.

[1] D. R. Carlson, D. D. Hickstein, W. Zhang, A. J. Metcalf, F. Quinlan, S. A. Diddams, and S. B. Papp, Science 361, 1358 (2018).

[2] S. A. Diddams, K. Vahala, and T. Udem, Science 369, eaay3676 (2020).

[3] T. J. Kippenberg, A. L. Gaeta, M. Lipson, and M. L. Gorodetsky, Science 361, eaan8083 (2018).

[4] L. Chang, S. Liu, and J. E. Bowers, Nature Photonics 16, 95 (2022).

[5] A. L. Gaeta, M. Lipson, and T. J. Kippenberg, Nature Photonics 13, 158 (2019).

[6] M.-G. Suh, Q.-F. Yang, K. Y. Yang, X. Yi, and K. J. Vahala, Science 354, 600 (2016).

[7] P. Marin-Palomo, J. N. Kemal, M. Karpov, A. Kordts, J. Pfeifle, M. H. P. Pfeiffer, P. Trocha, S. Wolf, V. Brasch, M. H. Anderson, R. Rosenberger, K. Vijayan, W. Freude, T. J. Kippenberg, and C. Koos, Nature 546, 274 (2017).

[8] D. T. Spencer, T. Drake, T. C. Briles, J. Stone, L. C. Sinclair, C. Fredrick, Q. Li, D. Westly, B. R. Ilic, A. Bluestone, N. Volet, T. Komljenovic, L. Chang, S. H. Lee, D. Y. Oh, M.-G. Suh, K. Y. Yang, M. H. P. Pfeiffer, T. J. Kippenberg, E. Norberg, L. Theogarajan, K. Vahala, N. R. Newbury, K. Srinivasan, J. E. Bowers, S. A. Diddams, and S. B. Papp, Nature 557, 81 (2018).

[9] M. A. Tran, C. Zhang, T. J. Morin, L. Chang, S. Barik, Z. Yuan, W. Lee, G. Kim, A. Malik, Z. Zhang, J. Guo, H. Wang, B. Shen, L. Wu, K. Vahala, J. E. Bowers, H. Park, and T. Komljenovic, Nature 610, 54 (2022).

[10] J. Riemensberger, A. Lukashchuk, M. Karpov, W. Weng, E. Lucas, J. Liu, and T. J. Kippenberg, Nature 581, 164 (2020).

[11] D. M. B. Lesko, H. Timmers, S. Xing, A. Kowligy, A. J. Lind, and S. A. Diddams, Nature Photonics 15, 281 (2021).

[12] U. Elu, L. Maidment, L. Vamos, F. Tani, D. Novoa, M. H. Frosz, V. Badikov, D. Badikov, V. Petrov, P. St. J. Russell, and J. Biegert, Nature Photonics 15, 277 (2021).

[13] A. Wirth, M. T. Hassan, I. Grguraš, J. Gagnon, A. Moulet, T. T. Luu, S. Pabst, R. Santra, Z. A. Alahmed, A. M. Azzeer, V. S. Yakovlev, V. Pervak, F. Krausz, and E. Goulielmakis, Science 334, 195 (2011).

[14] P. B. Corkum and F. Krausz, Nature Physics 3, 381 (2007).

[15] A. V. Muraviev, V. O. Smolski, Z. E. Loparo, and K. L. Vodopyanov, Nature Photonics 12, 209 (2018).

[16] N. Picqué and T. W. Hänsch, Nature Photonics 13, 146 (2019).

[17] C.-I. Chang, Hyperspectral Imaging (Springer US, 2003).

[18] M. Yu, D. Barton III, R. Cheng, C. Reimer, P. Kharel, L. He, L. Shao, D. Zhu, Y. Hu, H. R. Grant, L. Johansson, Y. Okawachi, A. L. Gaeta, M. Zhang, and M. Lončar, Nature 612, 252 (2022).

[19] Q. Guo, R. Sekine, J. A. Williams, B. K. Gutierrez, R. M. Gray, L. Ledezma, L. Costa, A. Roy, S. Zhou, M. Liu, and A. Marandi, Mode-locked laser in nanophotonic lithium niobate (2023), arXiv: 2306.05314.

[20] B. Stern, X. Ji, Y. Okawachi, A. L. Gaeta, and M. Lipson, Nature 562, 401 (2018).

[21] M. H. P. Pfeiffer, C. Herkommer, J. Liu, H. Guo, M. Karpov, E. Lucas, M. Zervas, and T. J. Kippenberg, Optica 4,684 (2017).

[22] Q. Li, T. C. Briles, D. A. Westly, T. E. Drake, J. R. Stone, B. R. Ilic, S. A. Diddams, S. B. Papp, and K. Srinivasan, Optica 4, 193 (2017).

[23] E. Obrzud, M. Rainer, A. Harutyunyan, M. H. Anderson, J. Liu, M. Geiselmann, B. Chazelas, S. Kundermann, S. Lecomte, M. Cecconi, A. Ghedina, E. Molinari, F. Pepe, F. Wildi, F. Bouchy, T. J. Kippenberg, and T. Herr, Nature Photonics 13, 31 (2019).

[24] T.-H. Wu, L. Ledezma, C. Fredrick, P. Sekhar, R. Sekine, Q. Guo, R. M. Briggs, A. Marandi, and S. A. Diddams, Visible to ultraviolet frequency comb generation in lithium niobate nanophotonic waveguides (2023), arXiv: 2305.08006.

[25] D. Yoon Oh, K. Y. Yang, C. Fredrick, G. Ycas, S. A. Diddams, and K. J. Vahala, Nature Communications 8, 13922 (2017).

[26] M. Ludwig, F. Ayhan, T. M. Schmidt, T. Wildi, T. Voumard, R. Blum, Z. Ye, F. Lei, F. Wildi, F. Pepe, M. A. Gaafar, E. Obrzud, D. Grassani, F. Moreau, B. Chazelas, R. Sottile, V. Torres-Company, V. Brasch, L. G. Villanueva, F. Bouchy, and T. Herr, Ultraviolet astronomical spectrograph calibration with laser frequency combs from nanophotonic waveguides (2023), arXiv: 2306.13609.

[27] J. M. Dudley, G. Genty, and S. Coen, Rev. Mod. Phys. 78, 1135 (2006)

[28] S. Vasilyev, I. Moskalev, V. Smolski, J. Peppers, M. Mirov, A. Muraviev, K. Vodopyanov, S. Mirov, and V. Gapontsev, Opt. Express 27, 16405 (2019).

[29] M. Jankowski, C. Langrock, B. Desiatov, A. Marandi, C. Wang, M. Zhang, C. R. Phillips, M. Lončar, and M. M. Fejer, Optica 7, 40 (2020).

[30] M. H. Anderson, R. Bouchand, J. Liu, W. Weng, E. Obrzud, T. Herr, and T. J. Kippenberg, Optica 8, 771 (2021).

[31] M. H. Anderson, W. Weng, G. Lihachev, A. Tikan, J. Liu, and T. J. Kippenberg, Nature Communications 13, 4764 (2022).

[32] S. Molesky, Z. Lin, A. Y. Piggott, W. Jin, J. Vucković, and A. W. Rodriguez, Nature Photonics 12, 659 (2018).

[33] P. L. McMahon, A. Marandi, Y. Haribara, R. Hamerly, C. Langrock, S. Tamate, T. Inagaki, H. Takesue, S. Utsunomiya, K. Aihara, R. L. Byer, M. M. Fejer, H. Mabuchi, and Y. Yamamoto, Science 354, 614 (2016).

[34] A. Marandi, N. C. Leindecker, V. Pervak, R. L. Byer, and K. L. Vodopyanov, Opt. Express 20, 7255 (2012).

[35] A. Marandi, K. A. Ingold, M. Jankowski, and R. L. Byer, Optica 3, 324 (2016).

[36] A. Roy, R. Nehra, S. Jahani, L. Ledezma, C. Langrock, M. Fejer, and A. Marandi, Nature Photonics 16, 162 (2022).

[37] L. Ledezma, R. Sekine, Q. Guo, R. Nehra, S. Jahani, and A. Marandi, Optica 9, 303 (2022).

[38] A. Roy, L. Ledezma, L. Costa, R. Gray, R. Sekine, Q. Guo, M. Liu, R. M. Briggs, and A. Marandi, Visible-to-mid-ir tunable frequency comb in nanophotonics (2022), arXiv: 2212.08723.

[39] L. Ledezma, A. Roy, L. Costa, R. Sekine, R. Gray, Q. Guo, R. Nehra, R. M. Briggs, and A. Marandi, Science Advances 9, eadf9711 (2023).

[40] R. Hamerly, A. Marandi, M. Jankowski, M. M. Fejer, Y. Yamamoto, and H. Mabuchi, Phys. Rev. A 94, 063809 (2016).

[41] S. Mosca, M. Parisi, I. Ricciardi, F. Leo, T. Hansson, M. Erkintalo, P. Maddaloni, P. De Natale, S. Wabnitz, and M. De Rosa, Phys. Rev. Lett. 121, 093903 (2018).

[42] L. G. Wright, F. O. Wu, D. N. Christodoulides, and F. W. Wise, Nature Physics 18, 1018 (2022).

[43] K. Krupa, A. Tonello, B. M. Shalaby, M. Fabert, A. Barthélémy, G. Millot, S. Wabnitz, and V. Couderc, Nature Photonics 11, 237 (2017).

[44] M. Leidinger, S. Fieberg, N. Waasem, F. Kühnemann, K. Buse, and I. Breunig, Opt. Express 23, 21690 (2015).

[45] N. Picque and T. W. Hänsch, Nature Photonics 13, 146 (2019).

[46] Y. Okawachi, M. Yu, B. Desiatov, B. Y. Kim, T. Hansson, M. Lončar, and A. L. Gaeta, Optica 7, 702 (2020).

[47] M. Yu, B. Desiatov, Y. Okawachi, A. L. Gaeta, and M. Loncar, Opt. Lett. 44, 1222 (2019).

[48] D. R. Carlson, D. D. Hickstein, A. Lind, J. B. Olson, R. W. Fox, R. C. Brown, A. D. Ludlow, Q. Li, D. Westly, H. Leopardi, T. M. Fortier, K. Srinivasan, S. A. Diddams, and S. B. Papp, Phys. Rev. Appl. 8, 014027 (2017).

[49] B. Spaun, P. B. Changala, D. Patterson, B. J. Bjork, O. H. Heckl, J. M. Doyle, and J. Ye, Nature 533, 517 (2016).

[50] B. J. Bjork, T. Q. Bui, O. H. Heckl, P. B. Changala, B. Spaun, P. Heu, D. Follman, C. Deutsch, G. D. Cole, M. Aspelmeyer, M. Okumura, and J. Ye, Science 354, 444 (2016).

[51] W. Weng, A. Kaszubowska-Anandarajah, J. He, P. D. Lakshmijayasimha, E. Lucas, J. Liu, P. M. Anandarajah, and T. J. Kippenberg, Nature Communications 12, 1425 (2021).

[52] Y. Xu, Y. Lin, A. Nielsen, I. Hendry, S. Coen, M. Erkintalo, H. Ma, and S. G. Murdoch, Optica 7, 940 (2020).

[53] E. Obrzud, S. Lecomte, and T. Herr, Nature Photonics 11, 600 (2017)

[54] T. Inagaki, K. Inaba, R. Hamerly, K. Inoue, Y. Yamamoto, and H. Takesue, Nature Photonics 10, 415 (2016).

[55] P. S. Devgan, J. Lasri, R. Tang, V. S. Grigoryan, W. L. Kath, and P. Kumar, Opt. Lett. 30, 1743 (2005).

[56] A. Roy, R. Nehra, C. Langrock, M. Fejer, and A. Marandi, Nature Physics 19, 427 (2023).

[57] K. A. Ingold, A. Marandi, M. J. F. Digonnet, and R. L. Byer, Opt. Lett. 40, 4368 (2015).

[58] C. Langrock and M. M. Fejer, Opt. Lett. 32, 2263 (2007).

[59] J. E. Sharping, M. Fiorentino, P. Kumar, and R. S. Windeler, Opt. Lett. 27, 1675 (2002).

[60] Y. Deng, Q. Lin, F. Lu, G. P. Agrawal, and W. H. Knox, Opt. Lett. 30, 1234 (2005).

[61] J. E. Sharping, M. A. Foster, A. L. Gaeta, J. Lasri, O. Lyngnes, and K. Vogel, Opt. Express 15, 1474 (2007).

[62] M. Gao, N. M. Lupken, K.-J. Boller, and C. Fallnich, in Optica Advanced Photonics Congress 2022 (Optica Publishing Group, 2022) p. JTh4A.3.

[63] A. Marandi, Z. Wang, K. Takata, R. L. Byer, and Y. Yamamoto, Nature Photonics 8, 937 (2014).

[64] O. H. Heckl, B. J. Bjork, G. Winkler, P. B. Changala, B. Spaun, G. Porat, T. Q. Bui, K. F. Lee, J. Jiang, M. E. Fermann, P. G. Schunemann, and J. Ye, Opt. Lett. 41, 5405 (2016).

[65] D. Reid, G. Kennedy, A. Miller, W. Sibbett, and M. Ebrahimzadeh, IEEE Journal of Selected Topics in Quantum Electronics 4, 238 (1998).

[66] R. Sekine, R. Gray, L. Ledezma, Q. Guo, and A. Marandi, in Conference on Lasers and Electro-Optics (Optica Publishing Group, 2022) p. SM5K.2.

[67] J. Li, C. Bao, Q.-X. Ji, H. Wang, L. Wu, S. Leifer, C. Beichman, and K. Vahala, Optica 9, 231 (2022).

[68] K. C. Burr, C. L. Tang, M. A. Arbore, and M. M. Fejer, Opt. Lett. 22, 1458 (1997).

[69] Further information on one or more embodiments of the present invention can be found in Multi-Octave Frequency Comb from an Ultra-Low-Threshold Nanophotonic Parametric Oscillator by Ryoto Sekine, Robert M. Gray, Luis Ledezma, Selina Zhou, Qiushi Guo, Alireza Marandi, https://arxiv.org/abs/2309.04545

### Supplementary Information for the Chip Design and Simulations of the First Embodiment

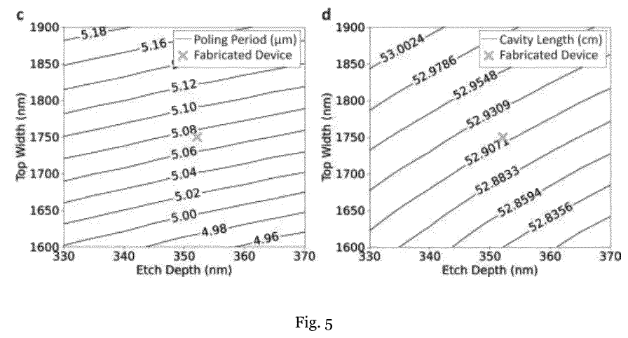

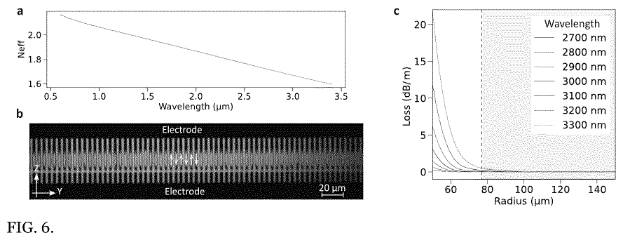

The spatiotemporal profile of pulses propagating through our nanophotonic waveguides can be sculpted by a few key fabrication parameters. Labeled in FIG. 5a, these are the lithium niobate (LN) thickness, etch depth, top width, and sidewall angle. All of these parameters directly affect the effective index of the waveguide which, in turn, determines the near-zero dispersion geometry, quasi-phase-matching poling period, and required cavity length for synchronous pumping of our OPO, as shown in FIGS. 5b-d. We fabricated our device with a constant poling period of 5.075 μm and a cavity length of 52.92 cm, and we measured a waveguide etch depth and top width of 352 nm and 1753 nm respectively. These dimensions are marked by crosses in FIG. 5b-d and show that we successfully engineered our device to be close to optimal parameters for phase-matched operation with near-zero GVM and GVD. The resulting simulated effective index, n_{eff}, and fabricated poling period are shown in FIG. 6, along with the simulated bending loss as a function of bend radius and wavelength. The dotted blue line in FIG. 6c at 77 μm indicates the minimum bend radius used in fabricating the spiral, showing small bending loss for wavelengths shorter than 3.3 μm at all points in the spiral.

### Input Output Coupler Design

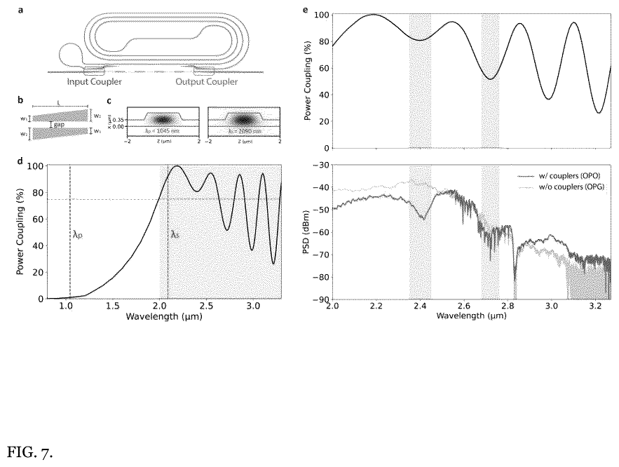

The input and output couplers of the OPO, as defined in FIG. 7a, are symmetrically identical and take the adiabatic shape depicted in FIG. 7b, where the parameters for w₁, w₂, gap, and L are 1753 nm, 1900 nm, 980 nm, and 750 μm respectively. Adiabatic couplers were chosen for their broadband response and comparative fabrication insensitivity compared to other coupler geometries. The simulated fundamental TE mode profiles at 1 μm and 2 μm for the waveguide design with top width w₂ are shown in FIG. 7c. Pulses propagating through this adiabatic coupler follow the coupled mode equations,

$$\{ \begin{matrix}\frac{d {a}_{1}}{d z} = - j κ {e}^{j Δ β z} {a}_{2} ( z ) \\ \frac{d {a}_{2}}{d z} = - j κ {e}^{- j Δ β z} {a}_{1} ( z )\end{matrix} \qquad ( 1 )$$

where α₁ and α₂ are the amplitudes of the modes in each waveguide, K is the coupling coefficient between the waveguides, and Δβ=|β₁−β₂| is the phase mismatch between the two waveguides. Solving eq. (1) for our geometry, we obtain the power coupling curve in FIG. 7d. We see that only signal wavelengths above 2 μm experience significant coupling. In FIG. 7e we compare the spectral output of our OPO (device with coupler and cavity) against that from an adjacent straight waveguide without any couplers but sharing the same poling and waveguide parameters. We find that the simulated dips and peaks in the adiabatic coupler are reflected in the measured spectra from the nanophotonic OPO but are absent from the periodically poled straight waveguide, matching our theoretically predicted coupler response.

### Setup

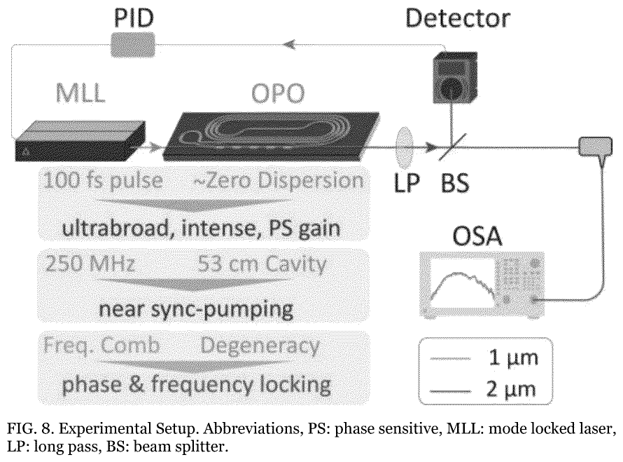

Our experimental setup is shown in FIG. 8. The detector in the PID loop allows the repetition rate of the pump comb to be locked to disparate oscillation peaks of the OPO while the spectra was collected on an optical spectrum analyzer (OSA). The synergistic features of the pump and OPO that enabled multi-octave frequency comb generation are emphasized in the figure.

### Extended Experimental Data to Three Octave Spectra

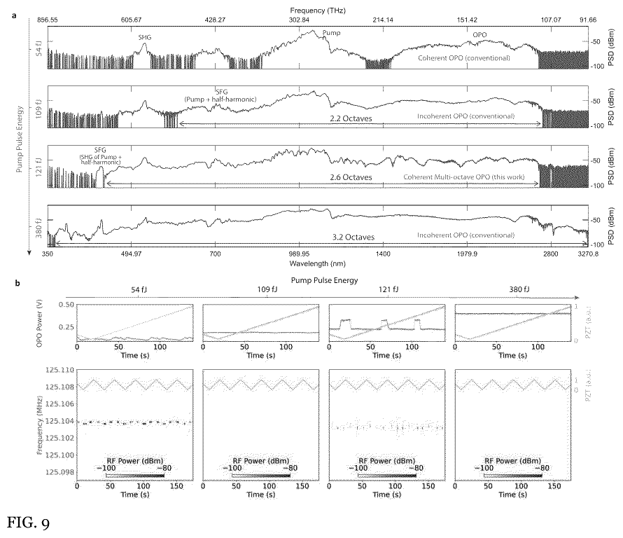

Using the experimental setup shown in FIG. 8, we investigated the output spectra of the OPO at different pump pulse energies, a subset of which was shown in FIG. 2d. FIG. 9a shows the extension to even higher pump pulse energies. At 380 fJ of pump, we observed three-octave-spanning spectra from 362 nm to 3261 nm. The beatnote analysis with a free space OPO shown in FIG. 9b however, following the procedure in Supplementary Section E1, indicates that the OPO here is incoherent.

### Molecular Absorption Features

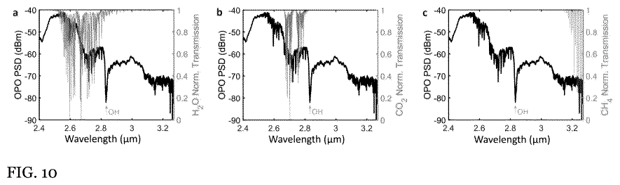

For the measured spectra above 2.5 μm in FIG. 9a, we observed features that appear to be from spectral absorption lines coming from ambient molecules. FIG. 10 compares the experimental OPO spectra to the spectral lines of H₂O, CO₂, and CH₄. The overlap between water and the OPO's spectral features is especially close, likely because H₂O is the strongest absorber in this spectral region at atmospheric concentrations. We calculate that 9% of the 3 μm mode inside the spiral region is evanescent, suggesting that with the 53 cm spiral, on-chip sensing may be possible. Here, however, we expect that the absorption primarily occurs between the output of the chip and the detector as none of the systems in this experiment were purged. Furthermore, these absorption features result from ambient molecules existing in the lab as no gas cells were prepared.

As noted above, the notch at 2.83 μm is due to an OH absorption peak in the LN and/or SiO₂ substrate buffer layer. Studies of the absorption of SiO₂ employed as a buffer layer for Si waveguides [2-4] indicate that the SiO₂ bottom-cladding will become prohibitively narrow around 2.8 μm and above 3.5 μm. For current thin-film lithium (TFLN) niobate devices with a SiO₂ buffer and Si substrate, the upper absorption appears to set in around 3.25 μm [5]. Wavelengths between, 2.8-3.8 μm, however have been measured on TFLN waveguides on a sapphire substrate [6], suggesting a path towards making a multi-octave frequency comb with even longer wavelength components.

### Mode Crossings

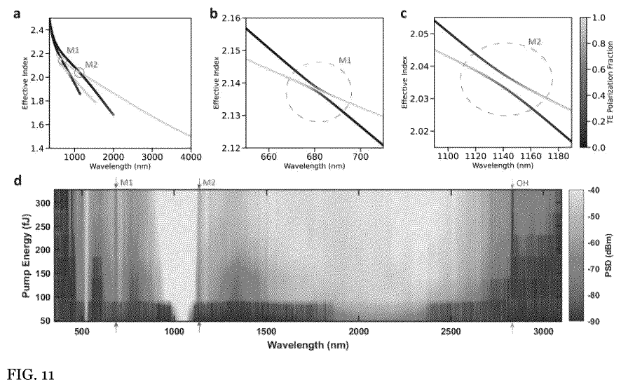

In FIG. 9, there are spectral kinks at 680 nm and 1135 nm evident over all pump pulse energies. These correspond to the two mode crossings shown in FIG. 11a. M1 is the mode crossing between the fundamental TE mode and second order TM mode (FIG. 11b) whereas M2 is the mode crossing between the fundamental TE and TM modes (FIG. 11c). Indeed, these mode crossings, as well as the OH absorption discussed in Section IIB, are even evident in the spectra measured from a straight waveguide with the same waveguide geometry and poling period as the OPO and plotted in FIG. 11d. As this straight waveguide does not have a cavity, its half-harmonic spectra is due to optical parametric generation (OPG).

### Beat Note Down Conversion

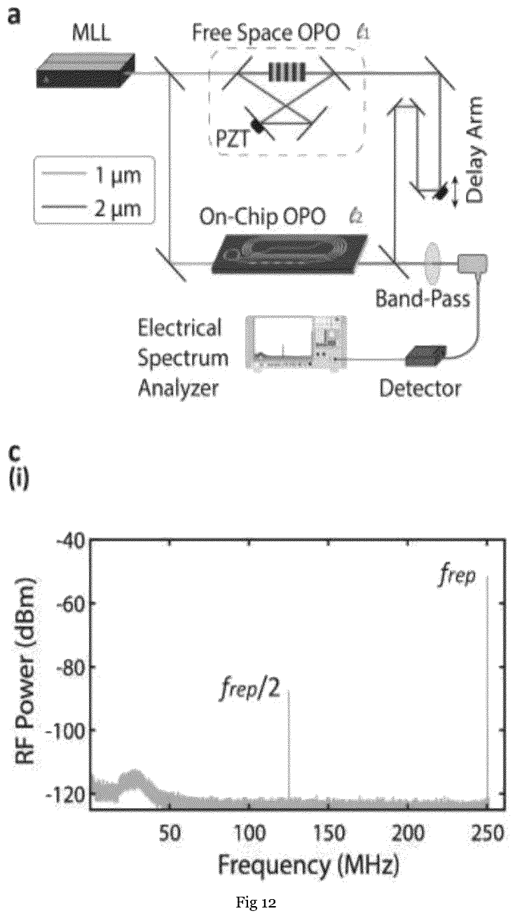

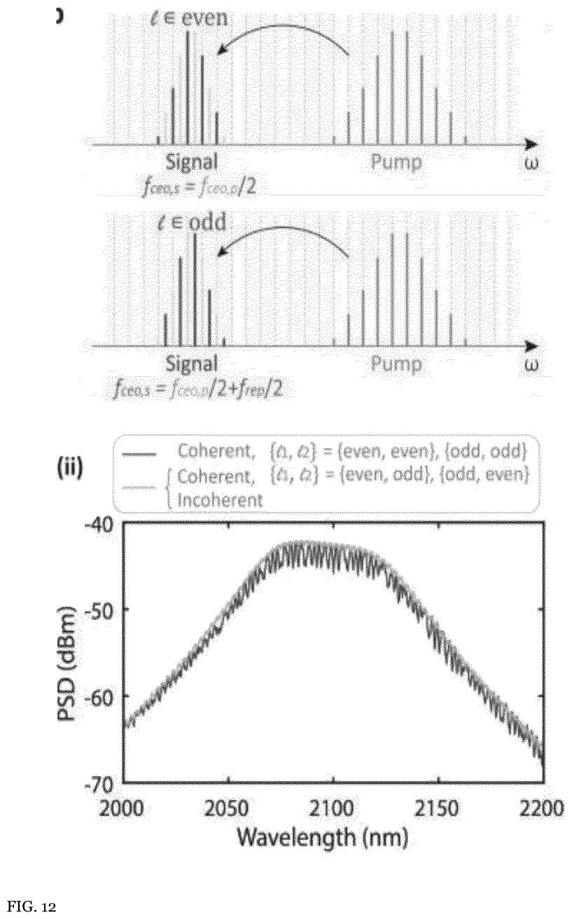

The coherence of the down-converted portion of the comb around the half-harmonic was investigated using the experimental setup in FIG. 12a. The output of an on-chip and free space OPO pumped by the same laser were interfered. Depending on the detuning peak l of each OPO, we expect to see different signatures in their radio frequency (RF) spectrum and interference patterns. Here, the dimensionless detuning parameter l=2fₛΔT_{RT}, where ΔT_{RT} is the mismatch between the cavity roundtrip time and pump repetition period, and fₛ is the signal frequency. While OPOs with even I have comb lines aligned with that of the pump, OPOs with odd l have comb lines shifted by fᵣₑₚ/2 [7,8]. This is illustrated in FIG. 12b. As a result, when one of the OPOs has even l while the other has odd l, the temporally and spatially overlapped OPO outputs show an f_{CEO} beatnote at fᵣₑₚ/2, as shown in the RF spectrum measurement in FIG. 12c(i). Furthermore, in this case where the two combs have different f_{CEO} frequencies, we do not expect to see interference fringes as the delay between the two coherent OPO outputs is scanned. As shown by the orange trace in FIG. 12c(ii), no fringe was observed.

In the case that the OPOs are coherent and share the same even or odd detuning parameter, and thus the same f_{CEO}, however, we do not expect and did not observe a beatnote at fᵣₑₚ/2. Furthermore, since the combs share an f_{CEO}, we expected to see an interference fringe as their relative delay was scanned. This is indeed what we measured, as shown by the blue curve in FIG. 12c(ii). At 109 fJ and 380 fJ of pump, where the down-converted portion of the nanophotonic OPO output is incoherent, we observed neither a fᵣₑₚ/2 beatnote nor the blue interference fringe of FIG. 12c(ii).

Finally, the pump rep rate can be locked to features in the OPO output signal. FIG. 12 shows that we can indeed lock to, and stabilize the on-chip OPO output to the 2.6 octave comb state in the temporal self-cleaning regime.

### Upconversion Beatnote

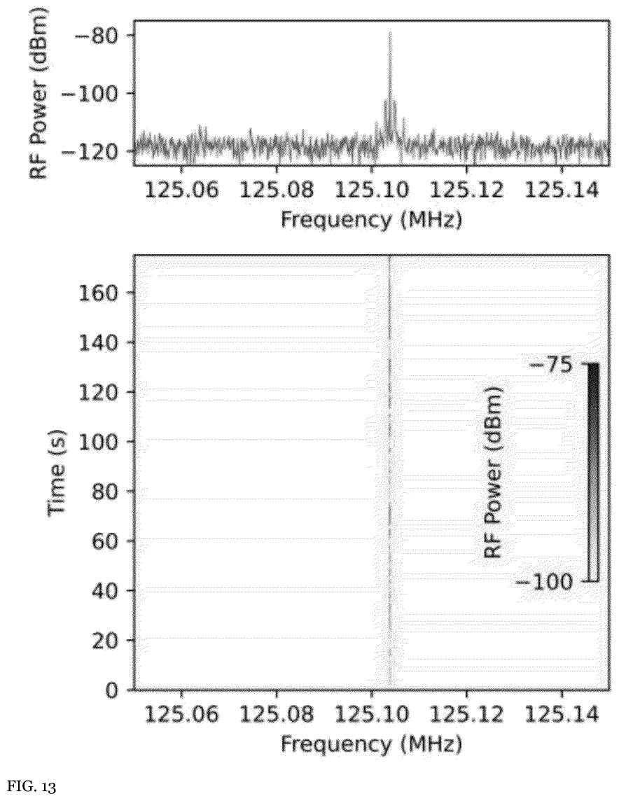

The coherence of the up-converted portion of the pump was investigated using similar methodologies to [9,10]. Specifically, a spectrally broadened portion of the pump was interfered with the second harmonic portion of the onchip OPO, as illustrated in FIG. 13a. The spectral overlap for three of the pump pulse energies mentioned in FIG. 2d are shown in FIG. 13b, with the corresponding beatnotes presented in FIGS. 13c-e. In each case we confirmed the beatnotes correspond to the f_{CEO} by recording its shift as the pump f_{CEO} is tuned. We concluded that the up-converted portion of the pump remains coherent irrespective of the pump pulse energy or cavity detuning, which is as expected [9,10].

### Simulations

### A. Method

We model the ultrabroad spectral dynamics of the nanophotonic OPO by representing the total electric field in the nanophotonic waveguide using a single envelope in the frequency domain [11,12],

$$E ( x , y , ω ) = A ( z , Ω ) e ( x , y , ω ) {e}^{- i ( {β}_{0} - \frac{{ω}_{0}}{{v}_{r e f}} ) z} \qquad ( 2 )$$

where ω and Ω=ω−ω₀ are the optical and envelope angular frequencies, ω₀ is the simulation center frequency, β₀ is the waveguide propagation constant at ω₀, v_{ref} is the simulation reference frame velocity, x and y are the transversal waveguide coordinates, e(x, y, ω) is the mode transversal field distribution, and A(z, ω) is the complex amplitude of the field that evolves during propagation. In our OPO simulation, ω₀ is chosen to be the center of the half-harmonic signal at 2090 nm, and v_{ref} is the group velocity of the half-harmonic. A(z, ω)=A(z, Ω)e^{-iω}^{₀}^{t} is a rapidly-varying envelope which contains the phase factor e^{-iβ(ω)z} acquired during linear propagation. Additionally, A(z, ω) is an analytic signal, meaning it only contains positive frequencies (A(z, ω<0)=0).

Our simulation models each round-trip in the OPO in two parts. The first accounts for the nonlinear propagation in the poled region of the waveguide, while the second consists of a linear filter which models the round-trip evolution in the spiral resonator [13]. The output of this round-trip evolution is fed back as a seed for the subsequent nonlinear propagation. The first round-trip is seeded by white noise for all frequencies besides the pump, which is taken to be an 80-fs pulse with a sech pulse profile, centered at 1045 nm.

We find a uni-directional equation of motion describing the nonlinear propagation of A(z, Ω) by ignoring counterpropagating terms (which are usually phase mismatched) and assuming a constant nonlinear coefficient and mode overlap integral, both of which are weak functions of frequency away from any material resonances. No limitations are placed upon the maximum spectral bandwidth of the simulation. The resulting propagation equation is,

$$\frac{\partial A}{\partial z} = - i [ β ( ω ) - {β}_{0} - \frac{Ω}{{v}_{r e f}} - i \frac{α}{2} ] A - \frac{i {ωϵ}_{0} {X}_{0}}{8} d ( z ) {ℱ}_{Ω} \{ {a}^{2} ( z , t ) {e}^{j ϕ ( z , t )} + 2 a ( z , t ) {a}^{*} ( z , t ) {e}^{- j ϕ ( z , t )} \}$$

where d(z)=±1 is the sign of the quadratic nonlinear coefficient that is modulated in quasi-phase matching, a is the propagation loss coefficient, α(z, t) is the time domain representation of A(z, Ω), ϕ(z, t)=ω₀t−(β₀−ω₀/v_{ref})z, F_{Ω} is the Fourier transform in the Ω variable. The effective nonlinear coefficient X₀ is defined as:

$${X}_{0} = {\sum }_{ijk} {χ}_{i j k}^{( 2 )} \int {e}_{i}^{*} ( {ω}_{1} ) {e}_{j} ( {ω}_{2} ) {e}_{k} ( {ω}_{1} - {ω}_{2} ) dS \qquad ( 4 )$$

where Xᵢⱼₖ⁽²⁾ is the quadratic nonlinear susceptibility tensor, and j, k, l denote Cartesian components.

The nonlinear propagation in each round-trip involves solving the evolution equation (3) using the split-step Fourier technique over the length of the poled waveguide, L=10.8 mm. The nonlinear step employs the fourth-order RungeKutta method in the interaction picture (RK4IP) [14].

Propagation in the spiral resonator is modeled through application of a linear feedback function to the output of the poled region. In particular, the signal fed back to the input of the poled region for the (n+1)^{th} round-trip, Aᵢₙⁿ⁺¹(0, ω), is related to the field out of the poled region on the n^{th} round-trip, Aₒᵤₜⁿ(L, ω), by the expression:

$${A}_{i n}^{n + 1} ( 0 , ω ) = {A}_{out}^{n} ( L , ω ) R ( ω ) {e}^{- j ( {D}_{R T} ( ω ) {L}_{R T} + Δ {T}_{R T} ω + {ϕ}_{0} )} \qquad ( 5 )$$

Here, R(ω) is the frequency-dependent coupling factor of the designed adiabatic couplers,

$${D}_{R T} = β ( ω ) - {β}_{0} - \frac{Ω}{{v}_{r e f}} - i \frac{{α}_{R T}}{2}$$

is the complex dispersion operator describing propagation in the round-trip waveguide with parameters defined as above for the poled waveguide, L_{RT}=518.4 mm is the length of the round-trip cavity, ΔT_{RT} is the detuning parameter which accounts for any timing mismatch between the pump repetition period and cavity round-trip time, and ϕ₀ is a constant phase offset, which effectively represents the carrier-envelope offset phase, ϕ_{CEO}, of the pump. In addition to this fed back signal, a new pump pulse is also injected, centered at t=0 on the fast time axis.

Simulations are conducted on a Fourier grid of size 4096 with a bandwidth of 2.4 PHz. The corresponding time window is 1.7 ps. To avoid wrapping in the time window during the nonlinear propagation, a Tukey filter padded with zeros on the edges is applied in the time domain after each nonlinear step. Additionally, before application of the linear filter, all frequency components which will walk out of the time window over the course of the 518-mm propagation in the spiral resonator are filtered out. This has the undesirable effect of effectively reducing the simulated power in
frequency modes which are far from the reference frequency (and thus experience significant walk-off with respect to the reference velocity of the simulation), but it ensures the validity of the simulated nonlinear interaction.

In this context we consider nonlinear phase to be the phase accumulated in the PPLN section of the resonator due to the nonlinear process (excluding the linear phase accumulation). We explicitly focus on a narrow spectral range around the pump and its half-harmonic for the spectral analysis and around the peak intensities for the pump and half-harmonic in the temporal analysis.

B. OPO Dynamics under Different Conditions

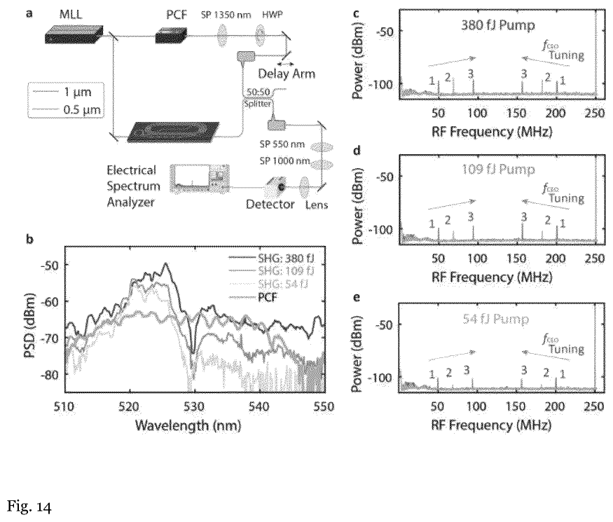

As discussed in the main text, the ultrabroadband OPO enters different regimes of operation high above threshold. An extended version of the regimes shown in the main text is shown in FIG. 14a. Whether our near-zero dispersion OPO can reach the coherent multi-octave state denoted as (iii) in the figure, largely depends on the pump energy, cavity detuning (shown in FIG. 14b), and effective pump carrier-envelope-offset phase, ϕ_{CEO}. We find that the dynamics of our OPO largely depend on whether it has an even or odd detuning peak, l, and whether its relative ϕ_{CEO} is 0 or π. We will dive into each of these cases in more depth below.

1. lϵ even, ϕ_{CEO}=0

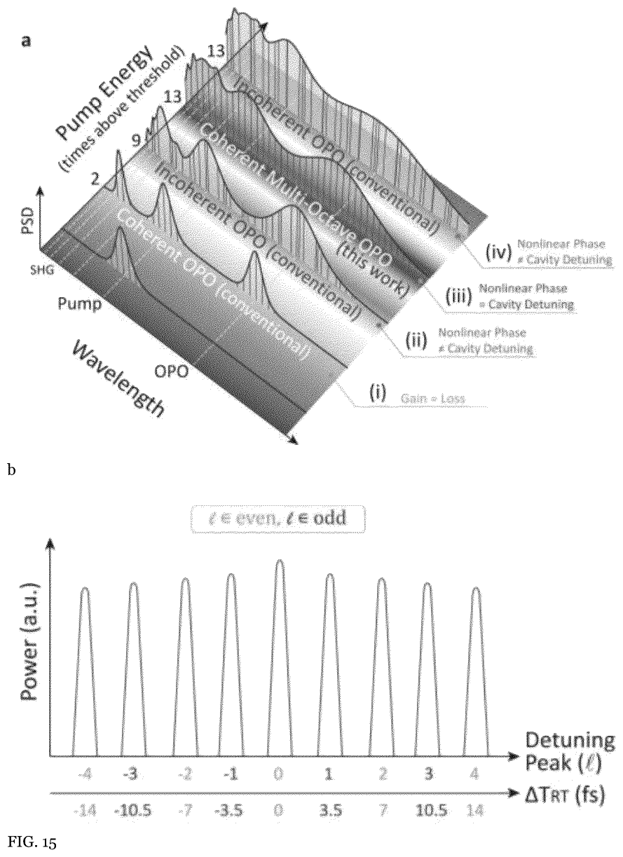

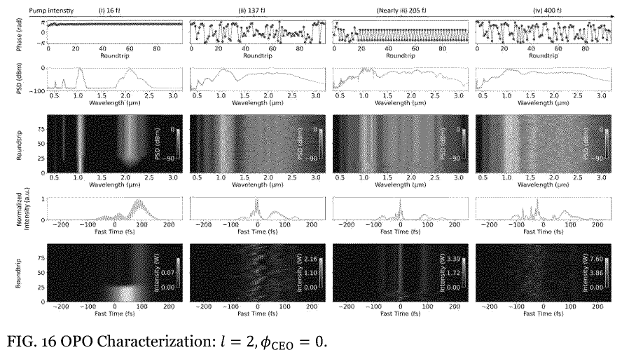

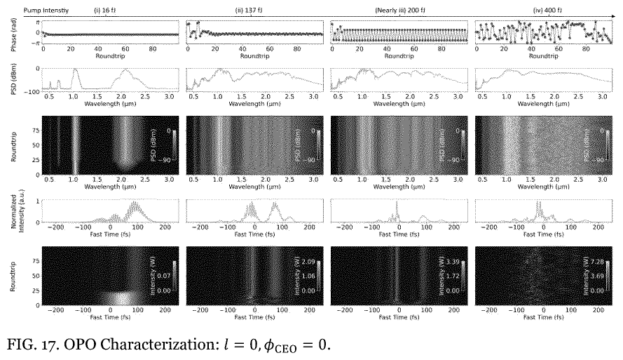

When lϵ even and ϕ_{CEO}=0, we find that while the OPO nearly reaches a coherent, mutli-octave comb, it never quite manages to. In the cases of l={2, 0, −2} in FIGS. 15-17, this is emphasized by the label (Nearly iii). In all of these cases we see that in regime (i) near threshold, the roundtrip-to-rountrip phase of the coherent OPO remains fixed once the OPO goes above threshold. After transitioning though an incoherent state in regime (ii), the OPO phase is seen to flip roundtrip-to-roundtrip by It in pump regime (iii). These periodic oscillations suggest that perhaps in this state the OPO is composed of two coherent non-degenerate combs, the beating of which creates the observed phase fluctuations as well as the roundtrip-to-roundtrip power fluctuations observed in the time- and frequency-domain plots of the OPO evolution. At even higher pump energies, the OPO enters the completely saturated, incoherent regime of (iv).

2. lϵ odd, ϕ_{CEO}=0

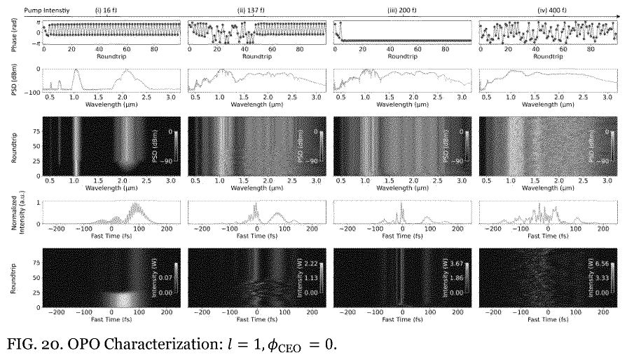

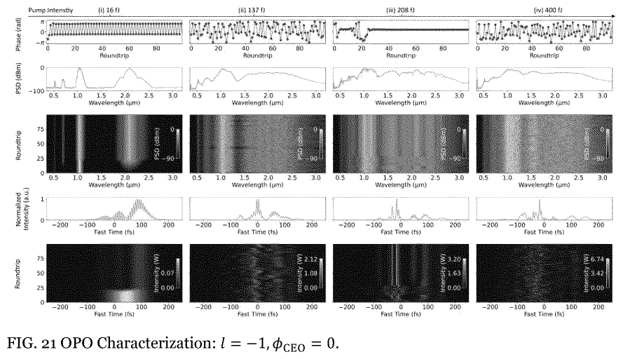

The roundtrip-to-roundtrip I phase flips in the ˜200 fJ-pumped cases when lϵ even and ϕ_{CEO}=0 suggest that if the cavity phase can be detuned by π, a multi-octave coherent comb can be sustained. One way of obtaining such a detuning is to select OPO peaks where l E odd while maintaining ϕ_{CEO}=0, and in FIGS. 20-21, we show the dynamics of the cases where l={3, 1, −1, −3}. As expected, near threshold, i.e. in regime (i), these OPOs show roundtrip-to-roundtrip I phase flips. In regime (iii), however, we find that the OPO demonstrates temporal self-cleaning and is able to stabilize, showing a fixed roundtrip-to-roundtrip phase.

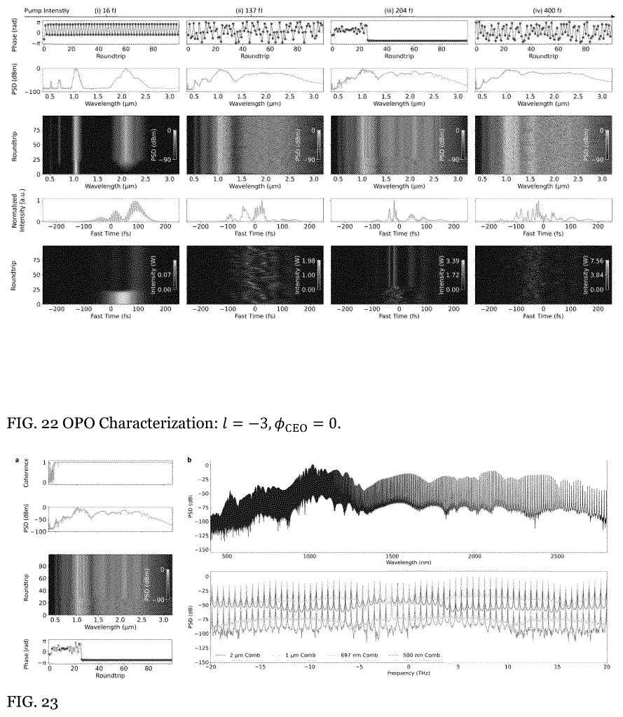

The coherence of the two octave spectra in regime (iii) can be further verified by means of calculating the g⁽¹⁾ coherence over pairs of output pulses as well as by directly inspecting the overlap of the half-harmonic, pump, second harmonic, and sum-frequency generated combs. As can be seen in the top panel of FIG. 22a, we see through measurement of the g⁽¹⁾ coherence between pairs of pulses taken from the last 15 roundtrips of our simulation, the device displays over two octaves of coherent spectra. This can be further verified by looking at the the actual comb lines of the two-octave comb. The full comb spectrum, as well as a close-up of the comb lines corresponding to different harmonic combs, shifted by the nearest multiple of fᵣₑₚ which centers them at zero, are shown in FIG. 22b. The good overlap between the comb lines is a further indication that the combs share an f_{CEO} and are thus coherent. Note that the second harmonic comb at 500 nm is not expected to share an f_{CEO} with the other harmonics except in the case where the pump comb at 1 μm has an f_{CEO} of 0, which is generally assumed in our simulation.

3. lϵeven, ϕ_{ceo}=π

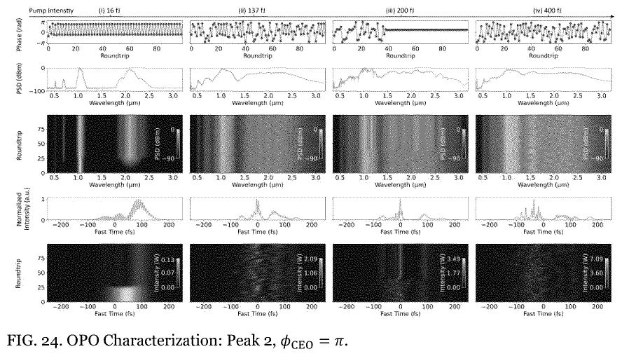

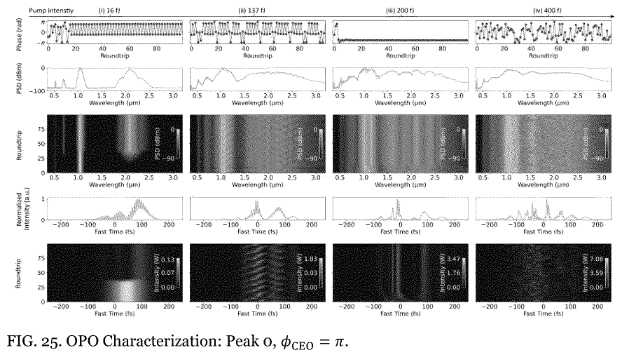

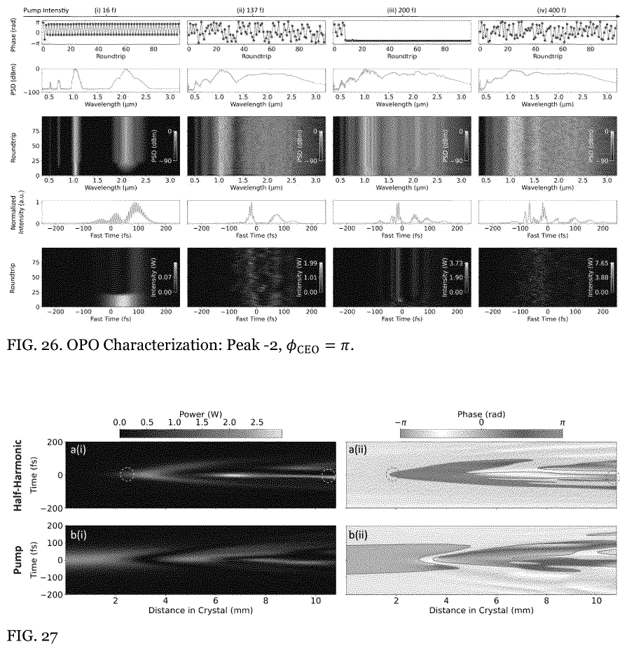

Along with picking an odd detuning peak, a roundtrip phase of It can be directly added in the case where lϵeven, corresponding to an effective pump carrier-envelope-offset phase ϕ_{CEO}=π. The results of this are shown in FIGS. 23-25 for l={2, 0, −2}. Similar to the case of lϵodd with ϕ_{CEO}=0, the OPO shows roundtrip-to-roundtrip phase flips at low powers of regime (i) and enters the oscillatory state of regime (ii) until ultimately landing in a steady-state at 200 fJ of pump. One qualification here is that, since the phase is added to the signal rather than the pump in simulation, the coherence between the pump and higher harmonics is also preserved, though this would not be true experimentally for a pump with non-zero ϕ_{CEO}, as discussed in Supplementary Section IIIC.

### C. Temporal Self-Cleaning

### 1. Mechanism

In FIG. 2d, we experimentally demonstrated that as the input pump pulse energy is increased, our OPO transitions from a conventional operational regime, where it is coherent, to an incoherent one, but then it recovers its coherence at higher pump pulse energies with an appropriate cavity detuning. In FIG. 27, we show the intensity and phase propagation of the pump and half-harmonic in the periodically poled region of the cavity at ˜200 fJ of pump (i.e. in the TSC regime). The evolution of the half-harmonic phase in a (ii) clearly shows a phase flip from −π→0 in locations where the half-harmonic has substantial intensity.

In Supplementary Section IIB, we showed that this π phase flip in the half-harmonic in each single-pass through the PPLN can be compensated by detuning the cavity by an odd number of OPO peaks (Section IIB2), or by adding a constant phase offset of π between the pump and cavity, corresponding to the carrier-envelope offset phase, ϕ_{CEO}, of the pump (Section IIB3). FIG. 22 is an example of the former. Near threshold (16 fJ), the OPO output experiences a n phase flip in every roundtrip, but it is able to stabilize to a constant phase output in the case of 204 fJ of pump. An example of the latter approach of choosing an even detuning peak but ϕ_{CEO} of π, is FIG. 24. Again, we observe that in the TSC regime of 200 fJ of pump, the output phase can stabilize after ˜40 cavity roundtrips. These examples show that compensating the single pass phase accumulation in the PPLN by appropriately detuning the cavity, or ϕ_{CEO}, is the key to operating in the TSC regime. Thus, the pump pulse energy of where TSC occurs is dependent on the OPO dispersion and nonlinear gain that induces π phase flips between the half-harmonic and the pump.

### 2. Short Pulse Formation

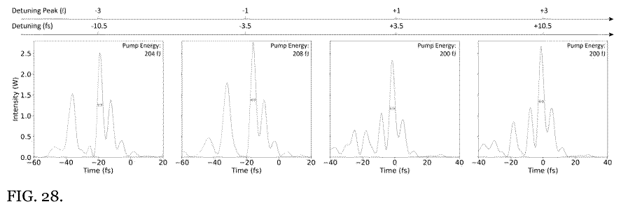

As mentioned in the main text, the temporal self-cleaning mechanism of the coherent multi-octave OPO can lead to ultrafast features at the output of the OPO. In FIG. 28, we explicitly show the simulated temporal output of this regime for the cases of l={−3, −1, 1, 3} with ϕ_{CEO}=0. Features as narrow as 4.2 fs can be observed, suggesting that the coherent multi-octave comb regime can in the future be leveraged for extreme pulse compression and single/few-cycle pulse synthesis.

### D. Extension to a Three Octave Comb

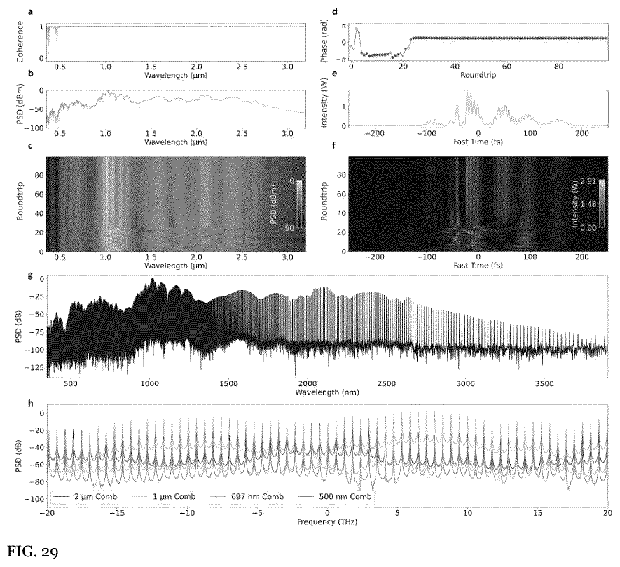

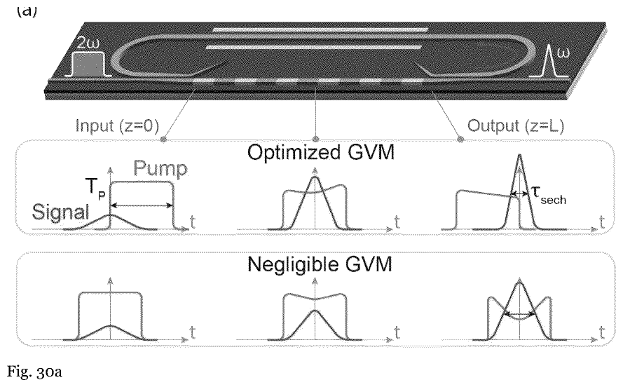

By employing a chirped poling period targeting energy transfer to the second harmonic and sum frequency generation terms, we can even induce three octaves of coherent spectra. In particular, the poling period in the last 1 mm of the 10.8-mm poled region is assumed to vary smoothly between the period required for quasi-phase-matched OPA between the pump at 1 μm and signal at 2 μm to phase matching the interaction between the pump at 1 μm and its second harmonic at 500 nm. Extended characterization of the results, discussed in FIG. 3b, are shown in FIG. 29. Of note is that this high-harmonic generation process acts as an effective loss for the 2 μm signal, resulting in a slightly higher threshold for the OPO and larger pump power requirement to reach the temporal self-cleaning regime. At 248 fJ of pump, however, a multi-octave comb is observed, with the additional high-harmonic processes enabling formation of a coherent three-octave spectrum (FIG. S25a-b) by filling the spectral gap between the second harmonic at 500 nm and sum-frequency component at 697 nm.

### References for the Supplementary Information

The following references are incorporated by reference herein.

[1] I. Gordon, L. Rothman, C. Hill, R. Kochanov, Y. Tan, P. Bernath, M. Birk, V. Boudon, A. Campargue, K. Chance, B. Drouin, J.-M. Flaud, R. Gamache, J. Hodges, D. Jacquemart, V. Perevalov, A. Perrin, K. Shine, M.-A. Smith, J. Tennyson, G. Toon, H. Tran, V. Tyuterev, A. Barbe, A. Császár, V. Devi, T. Furtenbacher, J. Harrison, J.-M. Hartmann, A. Jolly, T. Johnson, T. Karman, I. Kleiner, A. Kyuberis, J. Loos, O. Lyulin, S. Massie, S. Mikhailenko, N. MoazzenAhmadi, H. Müller, O. Naumenko, A. Nikitin, O. Polyansky, M. Rey, M. Rotger, S. Sharpe, K. Sung, E. Starikova, S. Tashkun, J. V. Auwera, G. Wagner, J. Wilzewski, P. Wcisło, S. Yu, and E. Zak, Journal of Quantitative Spectroscopy and Radiative Transfer 203, 3 (2017), hITRAN2016 Special Issue.

[2] R. A. Soref, S. J. Emelett, and W. R. Buchwald, Journal of Optics A: Pure and Applied Optics 8, 840 (2006).

[3] S. A. Miller, M. Yu, X. Ji, A. G. Griffith, J. Cardenas, A. L. Gaeta, and M. Lipson, Optica 4, 707 (2017).

[4] H. Lin, Z. Luo, T. Gu, L. C. Kimerling, K. Wada, A. Agarwal, and J. Hu, Nanophotonics 7, 393 (2018).

[5] A. Roy, L. Ledezma, L. Costa, R. Gray, R. Sekine, Q. Guo, M. Liu, R. M. Briggs, and A. Marandi, “Visible-to-mid-ir tunable frequency comb in nanophotonics,” (2022), arXiv: 2212.08723.

[6] J. Mishra, M. Jankowski, A. Y. Hwang, H. S. Stokowski, T. P. McKenna, C. Langrock, E. Ng, D. Heydari, H. Mabuchi, A. H. Safavi-Naeini, and M. M. Fejer, Opt. Express 30, 32752 (2022).

[7] A. Marandi, N. C. Leindecker, V. Pervak, R. L. Byer, and K. L. Vodopyanov, Opt. Express 20, 7255 (2012).

[8] M. Jankowski, Pulse formation and frequency conversion in dispersion-engineered nonlinear waveguides and resonators, Ph.D. thesis, Stanford University (2020).

[9] A. Marandi, K. A. Ingold, M. Jankowski, and R. L. Byer, Optica 3, 324 (2016).

[10] M. Jankowski, C. Langrock, B. Desiatov, A. Marandi, C. Wang, M. Zhang, C. R. Phillips, M. Lončar, and M. M. Fejer, Optica 7, 40 (2020).

[11] C. R. Phillips, C. Langrock, J. S. Pelc, M. M. Fejer, I. Hartl, and M. E. Fermann, Optics Express 19, 18754 (2011).

[12] L. Ledezma, R. Sekine, Q. Guo, R. Nehra, S. Jahani, and A. Marandi, Optica 9, 303 (2022).

[13] M. Jankowski, A. Marandi, C. Phillips, R. Hamerly, K. A. Ingold, R. L. Byer, and M. Fejer, Physical review letters 120, 053904 (2018).

[14] J. Hult, Journal of Lightwave Technology 25, 3770 (2007).

### Second Embodiment: Cavity Quadratic Soliton

Walk-off induced temporal soliton formation in a degenerate optical parametric oscillator (OPO) based on pure quadratic nonlinearity can serve as a tool to simultaneously compress and down-convert picosecond near-IR pulses. It has recently been shown, using a table-top experiment, that such quadratic cavity solitons can be supported in both normal and anomalous group-velocity dispersion regimes, and exist in low-finesse optical cavities that can lead to high conversion efficiencies [1]. Giant pulse compression exceeding a factor of 40 at picojoule level pump energy is also experimentally demonstrated. These results promise a way for the generation of energy-efficient dissipative quadratic solitons breaking some of the barriers for the generation of Kerr solitons which demand high Q cavities, feature limited conversion efficiency, require anomalous dispersion for bright soliton formation, and possess limited wavelength tunability. In this invention we form such a quadratic cavity soliton in LN nanophotonics.

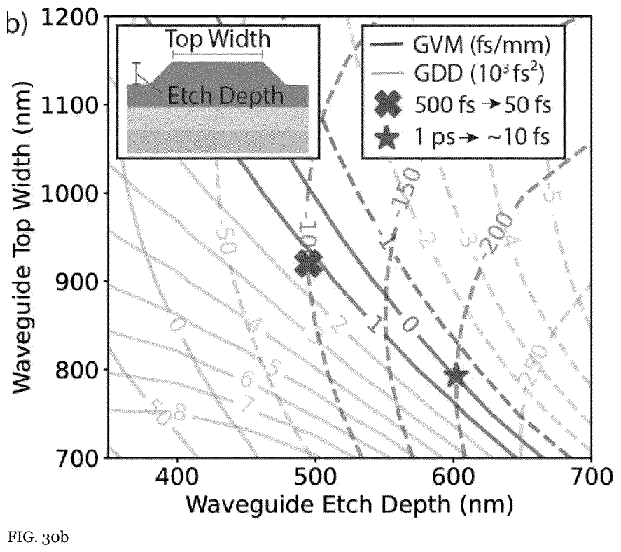

Synchronously pumped degenerate optical parametric oscillators (DOPOs) on thin film lithium niobate (TFLN) provide an unprecedented opportunity for extreme pulse compression with ˜100 fJ pump pulse energies, all on an integrated platform. The desired amount of pulse compression can be obtained by dispersion engineering the OPO's nanophotonic waveguides and can even compress a 1-ps pump pulse to ˜10 fs. The mechanics of how a synchronously pumped OPO can compress a pump pulse of pulse width Tₚ at frequency 2ω to a signal pulse of width τ_{sech} at frequency ω is detailed in [1 and illustrated in FIG. 30]. Group-velocity mismatch (GVM) between the pump and signal pulses causes the signal pulse to walk through the pump. The part of the signal pulse that overlaps the most with the pump experiences the maximum gain. When there is negligible GVM between the pump and signal, not only do all parts of the signal experience similar pump powers but also, the signal centroid is much more likely to reach gain saturation, both of which lead to significantly less pulse compression compared to the previous case. In fact, the optimal dispersion for pulse compression is when the signal centroid extracts the most energy from the pump by walking exactly through it, i.e. |GVM|=Tₚ/L_{PPLN}, where L_{PPLN} is the length of the periodically poled region. In this case the output pulse width is determined by the group delay dispersion (GDD) of the cavity, such that

$${τ}_{s e c h} = {( \frac{7}{15} \frac{{( G D D )}^{2} {T}_{p}}{ln ( {G}_{0} ) ln 2} )}^{\frac{1}{5}} \qquad ( 4 )$$

where G₀ is the gain at threshold. In the case where the second order dispersion can be eliminated, the output pulse width becomes limited by third order dispersion (TOD). Thus, in this scheme the amount of pulse compression available is determined by the amount of dispersion tunability that can be achieved.

Experiments and fundamental studies have been performed in a discrete-component cavity with limited dispersion engineering through optical fibers and outside the nonlinear gain medium. In contrast, TFLN allows for significant amount of dispersion engineering [2] and thus is an ideal platform for OPO based quadratic solitons and pulse compression. Simulation results in FIG. 30b show that by appropriately choosing the waveguide parameters, large GVM and small GDD regimes can be accessed, which are ideal for pulse compression. For example, the green cross denotes the geometry where a 500-fs pump will be compressed to 50 fs. The red star indicates where a 1-ps pump pulse will be compressed to the TOD limit of ˜10 fs.

Apart from the dispersion engineering, TFLN-based synchronously pumped OPOs are also desirable because of their very low operating pump powers. Low threshold energies of around ˜100 fJs have been measured [3], which is significantly lower than the pump powers that were required for other integrated means of pulse compression [1]. On top of this, TFLN allows for monolithic integration with other nanophotonic circuit elements such as heaters, mode-locked lasers, and other parametric processes. In summary, DOPOs on TFLN are an excellent platform for studying quadratic solitons with the goal of obtaining pulse compression on-chip from ˜1-ps pump pulses down to ˜10-fs signal pulses as illustrated in the dispersion-engineered waveguide design of FIG. 30b.

### References for Second Embodiment

The following references are incorporated by reference herein.

[1] A. Roy, R. Nehra, S. Jahani, L. Ledezma, C. Langrock, M. Fejer, and A. Marandi, Nature Photonics 16, 162 (2022).

[2] L. Ledezma, R. Sekine, Q. Guo, R. Nehra, S. Jahani, and A. Marandi, Optica 9, 303 (2022).

[3] A. Roy, L. Ledezma, L. Costa, R. Gray, R. Sekine, Q. Guo, M. Liu, R. M. Briggs, and A. Marandi, Visible-to-mid-ir tunable frequency comb in nanophotonics (2022), arXiv: 2212.08723.

### Third Embodiment of Visible to Infrared Combs Pumped by Frequency Combs

We demonstrate ultra-widely tunable frequency comb generation from on-chip OPOs in lithium niobate nanophotonics. Leveraging the ability to control the phase-matching via periodic poling combined with dispersion engineering, we show an on-chip tuning range that exceeds an octave. We pump the OPOs with picosecond pulses from an electro-optic frequency comb source in the near-IR, which is already demonstrated to be compatible with nanophotonic lithium niobate [18,58,59]. The demonstrated frequency combs cover the typical communication bands and extend into the mid-infrared spectral region beyond 3 μm with instantaneous bandwidths supporting sub-picosecond pulse durations. Additionally, the same chip produces tunable frequency combs in the visible resulting from up-conversion processes. Tunable visible frequency comb realization has been challenging owing to the absence of a suitable broadband gain medium and the typical large normal dispersion at these wavelengths in most integrated photonic platforms [14,30].

### Example Device Structure

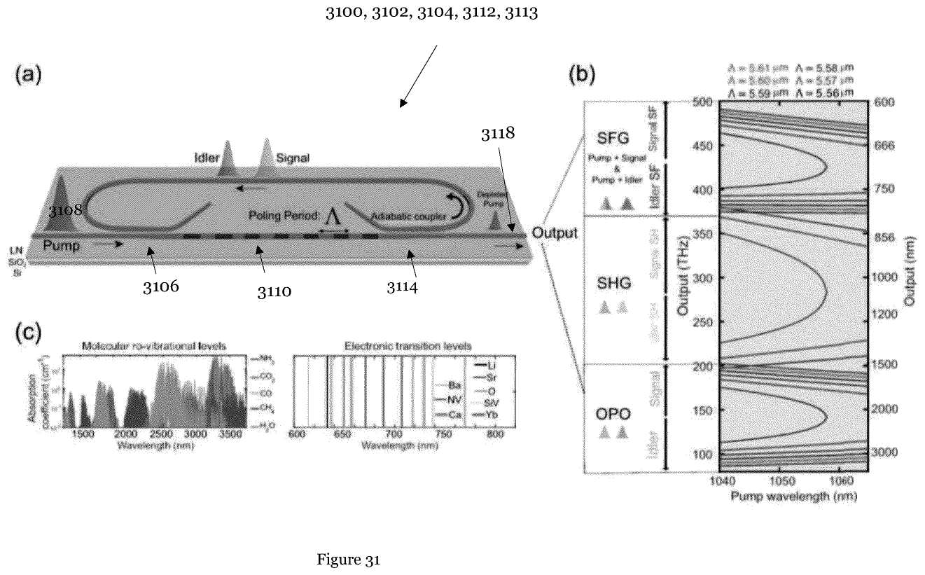

To achieve broadband and widely-tunable frequency combs, we designed a doubly-resonant OPO [15,24,40] based on nano-waveguides etched on X-cut 700-nm-thick MgO-doped lithium niobate, as illustrated in FIG. 31(a). Unlike triply-resonant designs [3,16,29], this design provides access to the wide tunability of quasi-phase-matching (QPM) and avoids stringent requirements such as ensuring the resonance of the pump [9]. Doubly resonant operation is achieved by controlling the precise spectral response of the OPO resonator using two spectrally selective adiabatic couplers (highlighted in FIG. 31(a)) that only let the long wavelengths (signal and idler) to resonate in the OPO while allowing the short wavelengths (pump and up-converted light) to leave the cavity (see Supplementary Section 3.6.2). This is not only important for achieving a broad tuning range for the signal and the idler, but it also enables non-resonant broadband and widely tunable up-conversion into the visible, which is in stark contrast with previous parametric sources in that range [14,30]. Another important aspect of the on-chip OPO design is the dispersion engineering of the main interaction waveguide of the OPO, which in combination with periodic poling leads to broad spectral coverage of the QPM tuning. Engineering the dispersion of the remainder of the resonator is another important design degree of freedom that can be further utilized for achieving quadratic solitons and pulse compression mechanisms [41].

For the data presented herein, quadratic parametric nonlinear interactions take place in a 5-mm—long poled waveguide region, which had a fixed poling period (Λ) for each OPO on the chip. The periodic poling phase matched parametric nonlinear interaction between the pump, the signal, and the idler waves which can be tuned from degeneracy to far non-degeneracy. The chip consisted of multiple OPOs with poling periods for type-0 phase matching of down-conversion of a non-resonant pump (in this case at around 1 micron wavelength) to an octave-spanning range of resonant signal and idler wavelengths, i.e., the OPO output. The QPM tuning curves are shown in FIG. 31(b). In addition to these OPO outputs, the poled waveguide also provided additional parametric up-conversion processes, notably the second-harmonic of the signal/idler, and the sum-frequency generation from the pump and signal/idler. The overall tuning range of the chip overlapped with many molecular and atomic transitions as illustrated in FIG. 31(c). The strong spatiotemporal confinement of the interacting waves in the waveguide guarantees substantial up-conversion efficiencies which can be further enhanced with the addition of proper poling periods and tailoring to specific applications (see Supplementary Section 3.6.1).

As shown in FIG. 31(b), to continuously cover the visible to the mid-infrared, we tuned the QPM by coarsely switching the poling period as well as fine-tuning the pump wavelength over ˜25 nm. This tuning range for the pump is compatible with the existing semiconductor lasers [50]. Moreover, the coarse switching of the poling period can be achieved without mechanical movements for instance by means of electro-optic routing (see Supplementary Section 3.6.8). In addition, temperature tuning of the poled region can provide another substantial tuning mechanism (see Supplementary Section 3.6.9 pf the supplementary information). The emission from the OPO chip covered important wavelengths corresponding to atomic transitions in the visible as well as molecular absorption lines in the mid-infrared (FIG. 31(c)).

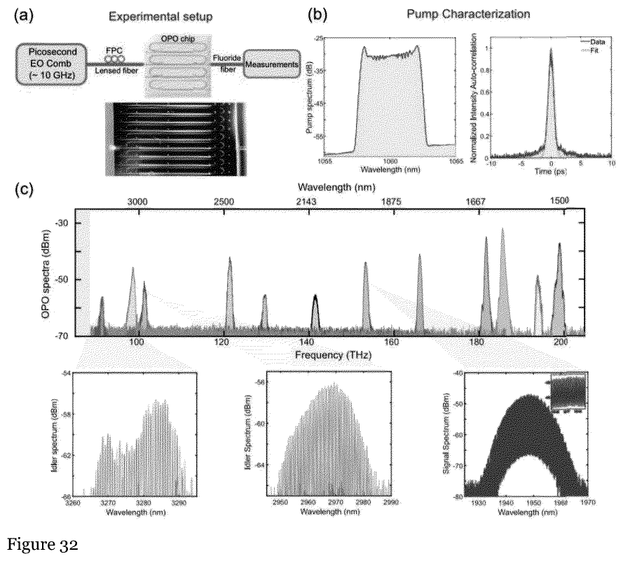

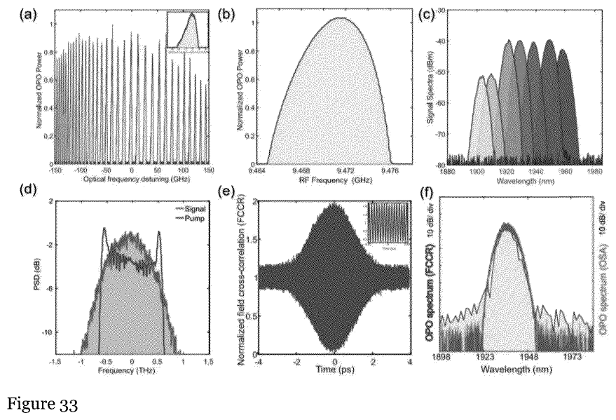

The OPO was synchronously pumped [27, 36, 40] by ˜1-ps—long pulses operating at a repetition rate of approximately 19 GHz. The repetition rate was tuned close to the OPO cavity free spectral range or its harmonics (see Supplementary Section 3.6.5). The octave-wide tunability of the parametric oscillation from the OPO chip was obtained by tuning the pump central wavelength between 1040 nm and 1065 nm only. The pump was generated from an electro-optic frequency comb (see Supplementary Section 3.6.3). The schematic of the experimental setup is shown in FIG. 32(a). The spectral and temporal characteristics of the near-infrared pump are shown in FIG. 32(b).

### Example Results

FIG. 32(c) shows the broad spectral coverage of the OPO output extending up to 3.3 μm in the mid-infrared obtained from a single chip. The comb lines can be resolved by the optical spectrum analyzer (OSA) and can be seen in the inset, where the separation of the peaks corresponds to the pump repetition rate. The on-chip threshold amounts to approximately 1 mW of average power (˜50 mW of peak power, and ˜100 femtojoules of pulse energy) for the near-degenerate OPOs. The signal conversion efficiency approaches ˜5% for the near-degenerate OPOs, while the mid-infrared (3.3 μm) idler conversion efficiency exceeds 1% for the far non-degenerate OPOs (see Supplementary Section 3.6.2). This corresponds to an estimated ˜25 mW of peak power and ˜5 μW of power per comb line in the mid-infrared.

The doubly-resonant operation of the OPO is also confirmed by the appearance of the resonance peak structure with the variation of the pump central wavelength as shown in FIG. 33(a). FIG. 33(b) shows the tolerance of the synchronous pumping repetition rate mismatch with respect to the optimum OPO operating point. The fine tunability of the OPO output spectra as offered by tuning the pump wavelength is depicted in FIG. 33(c). The combination of fine tunability and course tunability potentially enables continuous spectral coverage across the accessible spectral region. The OPO output at degeneracy (FIG. 33(d)) corresponds to a sub-picosecond transform-limited temporal duration (˜400 fs), representing a pulse compression factor exceeding 2 with respect to the pump (see Supplementary section 3.6.6).

We further evaluated the coherence of the output frequency comb by performing a linear field cross-correlation of the output signal light as shown in FIG. 33(e), where each OPO pulse was interfered with another pulse delayed by 10 roundtrips. The presence of the interference fringes (see inset of FIG. 33(e)), combined with the consistency of the Fourier transform of the cross-correlation trace and the signal spectrum obtained using an OSA, serve as evidence for the coherence of the output frequency comb over the entire spectrum (see FIG. 33(f)).

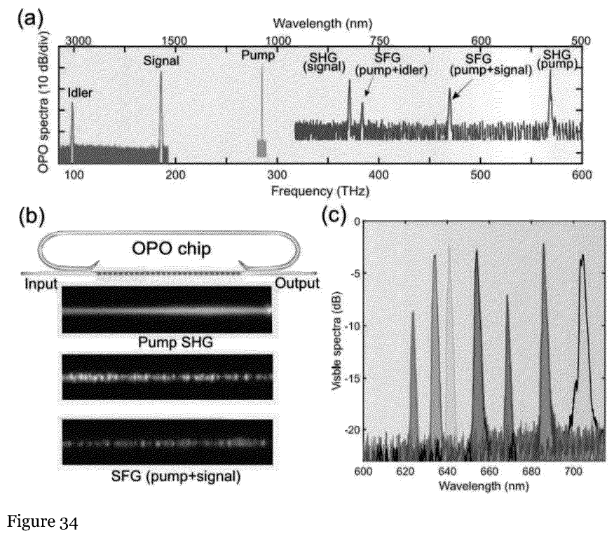

The occurrence of other quadratic nonlinear processes, such as second harmonic generation (SHG) and sum-frequency generation (SFG), leads to frequency comb formation in the visible spectral region. The complete emission spectrum of an OPO consisting of the second harmonic of the pump and the signal waves, the sum frequency components between the pump and the signal/idler waves along with the usual signal/idler is shown in FIG. 34(a). The scattered visible light emanating from the chip is captured by the optical microscope image (see FIG. 34(b)) showing the emission of the pump second harmonic (green) and the sum frequency components (red). In the poling region, green dominates at the input side, which progressively is overpowered by the sum-frequency red component. The SFG between the pump and the signal waves leads to tunable visible frequency comb generation between 600 nm and 700 nm as shown in FIG. 34(c). Tuning the OPO farther from degeneracy leads to idler emission further into the mid-IR as well as the SFG component that lies to the bluer side of the visible spectrum.

The pump, which is a near-IR electro-optic comb, can be incorporated into the lithium niobate chip [6,59]. With proper dispersion engineering, our OPO design can additionally achieve large instantaneous bandwidth accompanied by significant pulse compression [41], enabling the generation of femtosecond mid-infrared frequency combs in nanophotonics. Efficient supercontinuum generation requiring only a couple of picojoules of pulse energy can then be performed using periodically-poled lithium niobate waveguides on these femtosecond pulses for subsequent f-2f self-referencing/comb stabilization [20].

In one or more embodiments, the OPO can be integrated with electro-optic modulators for active locking of the OPO frequency comb. The on-chip OPO threshold can be reduced further by improving waveguide losses and enhancing the effective nonlinear co-efficient by separately optimizing the modal overlap between the pump and the signal/idler fields for each OPO device catering to dedicated spectral bands. We estimate that an on-chip threshold for operation near degeneracy with an average power less than 500 μW (for 10 GHz repetition rate operation) is feasible. The low power requirement combined with the need for a relatively narrow pump tunability range allows for pumping the OPO chip with butt-coupled near-infrared diode lasers and fully integrated solution for mid-IR frequency comb generation based on lithium niobate nanophotonics [13,18,25,58] (see supplementary section 3.6.8).

Optimizing the coupler design can enable OPO operation with lower thresholds and higher mid-infrared comb conversion efficiency. Advanced coupler designs like the ones based on inverse design can satisfy the simultaneous requirements of low coupling for the pump, high coupling for the signal, and optimum coupling for the idler waves, leading to conversion efficiencies even exceeding 30%. Realizing OPO devices in lithium niobate on sapphire will give access to a wider transparency window, leading to frequency comb generation deeper into the mid-infrared [34]. Thanks to the strong parametric nonlinear interaction, it is possible to realize frequency combs with lower repetition rates (˜1 GHz) using spiral waveguides [26] in the feedback arm of the OPO resonator which will be useful for on-chip dual-comb spectroscopy applications. The emission in the mid-infrared overlaps with important molecular rovibrational absorption lines and paves the way for novel integrated spectroscopic solutions.

### Methods and Supplementary Information on the Third Embodiment

The devices were fabricated on a 700 nm thick X-cut MgO-doped lithium niobate on silica die (NANOLN). Periodic poling was performed by first patterning electrodes using e-beam lithography, followed by e-beam evaporation of Cr/Au, and subsequently metal lift-off. Ferroelectric domain inversion is undergone by applying high voltage pulses, and the poling quality is inspected using second-harmonic microscopy. The waveguides were patterned by e-beam lithography and dry-etched with Ar⁺plasma. The waveguide facets are polished using fiber polishing films. The OPO-chip consists of multiple devices with poling periods ranging from 5.55 μm to 5.7 μm (in 10-nm increments) that provides parametric gain spanning over an octave.

Optical spectra were recorded using a combination of a near-infrared optical spectrum analyzer (OSA) (Yokogawa AQ6374), mid-infrared OSAs (Yokogawa AQ6375B, AQ6376E), and a CCD spectrometer (Thorlabs CCS200). The OPOs are synchronously driven at either the fundamental repetition rate (˜9.5 GHz) or its harmonic (˜19 GHz). The optical spectrum results are obtained with the harmonic repetition rate operation as it leads to wider instantaneous bandwidth owing to shorter electro-optic pump pulses. The OPOs operating at longer wavelengths have higher thresholds (because of increased effective area, increased coupler loss corresponding to the signal wave, and larger mismatch between the relative walk-off parameters of the signal and the idler wave) and therefore, we operate them intermittently in what we call “quasi-synchronous” operation, as a way to reduce the average power and avoid thermal damage (see Supplementary Section 3.6.4). This limitation is mainly attributed to the avoidable input insertion loss (˜12 dB) of our current setup. With the aid of better fiber-to-chip coupling design/mechanisms (insertion loss of the order of 1 dB has been reported in the context of thin-film lithium niobate) the mid-IR OPOs can be operated in a steady state sync-pumped configuration [17].

### 3.6 Single Envelope Simulations and Visible Frequency Comb

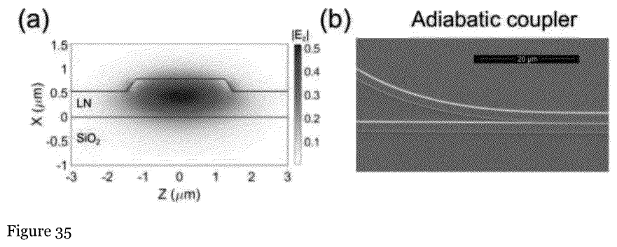

To capture the process of the generation of the second-harmonic and sum-frequency generation signals (responsible for the generation of the visible frequency comb), we resort to single nonlinear envelope simulation [5]. The numerically obtained results are shown in FIG. 35(a), which alludes to the existence of the visible frequency comb components. We have assumed the presence of non-idealities in the poling period in our simulation. These second-harmonic and sum-frequency generation components are generated due to parasitic phase-matching owing to duty-cycle errors and/or higher-order phase-matching for the visible components.

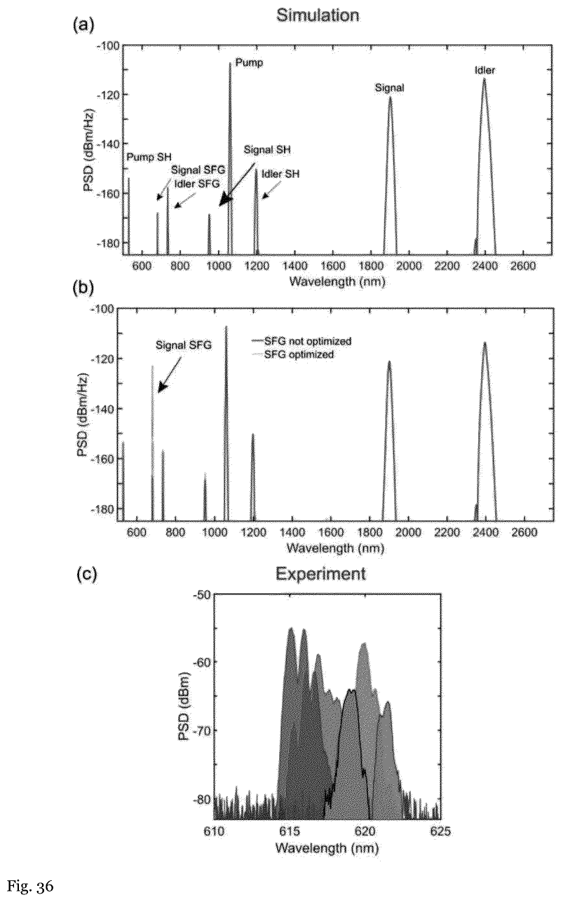

In order to enhance the efficiency of the visible frequency comb generation process one can add an additional phase matching section at the output waveguide of the OPO. This would boost the conversion efficiency for the phase-matched component, and can also be designed to be broadband using chirped poling periods. Such a scenario where the efficiency of the SFG component between the pump and the signal is boosted is simulated in FIG. 36(b). Similarly, it can also be designed for the other components, namely the SFG of the idler and the pump, or the second harmonic frequency combs. We note that these visible frequency combs are singlepass due to the long-pass nature of the spectral response of the adiabatic couplers. The visible components inherit their wide tunability for their parent signal/idler frequency combs.

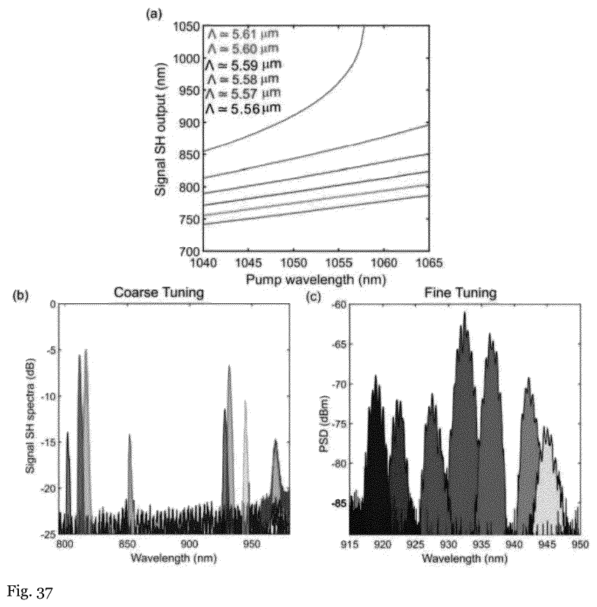

The fine tunability of the visible frequency comb (sum frequency generation between the signal and the pump) can also be performed using pump wavelength control as shown in FIG. 36(c). The up-conversion resulting from the second-harmonic generation of the signal also leads to near-infrared frequency comb generation. The phase-matching curves are shown in FIG. 37(a). The coarse tuning and fine-tuning of the second-harmonic signal comb as obtained experimentally are shown in FIG. 37(b) and FIG. 37(c), respectively.

### 3.6.2 Signal/Idler Conversion Efficiency

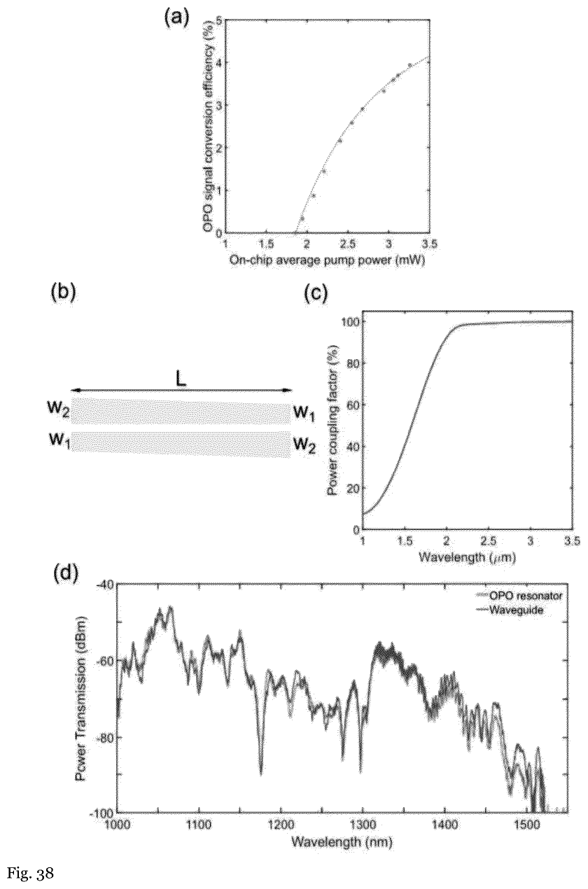

FIG. 38a plots the signal power as a function of the pump power. The OPO conversion efficiency is a function of the escape efficiency, number of times above threshold operation, etc., [2].

The escape efficiency is determined by the OPO-cavity output coupling, which is given by the frequency response of our adiabatic coupler. The schematic of the geometry of our coupler is shown in FIG. 38(b). The geometrical parameters are mentioned in the caption of FIG. 40. The simulated performance from the coupler is shown in FIG. 38(c). The coupler response is also characterized experimentally by illuminating with a super-continuum source. The results are overlaid in FIG. 38(d).

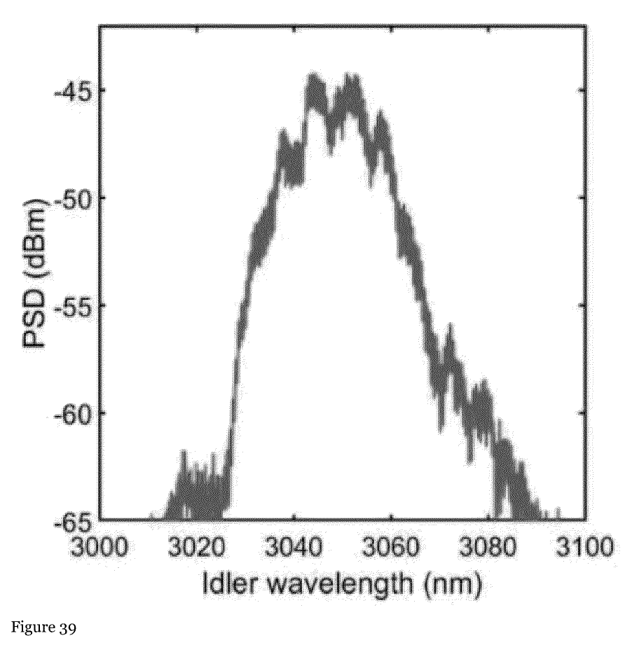

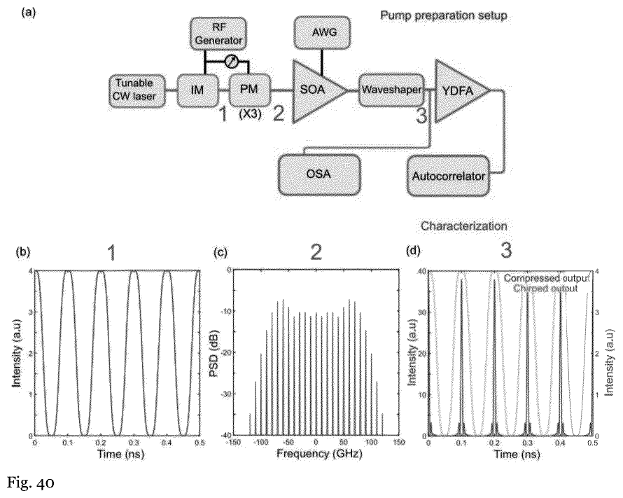

We measure an off-chip mid-infrared power of ˜300 nW. The spectrum is shown in FIG. 39. The corresponding on-chip average power is ˜3 μW. The estimated pulse width for the idler is ˜500 fs (transform-limited). This indicates a peak power of ˜ of 25 mW. The power per comb line is ˜5 μW. Note that we have multiplied the power levels with the quasi-pulse duty cycle of 100. The threshold of the extreme mid-infrared OPO is estimated to be approximately 10 times that of the near-degenerate OPO (possessing a threshold of ˜1 mW of average power).

### 3.6.3 Pump Preparation/Electro-Optic Frequency Comb Generation

The OPO was pumped by an electro-optic frequency comb whose repetition rate is tuned close to the cavity FSR. The pump pulse width was approximately 1 ps long and based on the available electronics in our current version the repetition rate can be tuned from 5 GHz to 20 GHz (the upper limit is dictated by the bandwidth of the RF amplifiers). The electro-optic frequency comb generation scheme closely follows the approach demonstrated in [33,39]. The center frequency can be tuned from 1040 nm to 1065 nm (the upper limit is determined by the operating range of the waveshaper, while the lower limit is chosen to ensure the safe operation of the YDFA).

The schematic of the pump preparation setup is shown in FIG. 40(a). The output of the CW laser was modulated by a series of modulators. The modulators are driven by an RF signal generator followed by an RF amplifier. The Intensity modulator (IM) bias is chosen such that pulses can be carved out from the continuous wave. At this stage (Stage 1) the time domain output resembles the simulated waveform shown in FIG. 40(b). Next, a cascade of 3 Phase modulators (PM) enables the addition of spectral sidebands which are separated by the repetition rate. The Phase modulators are driven in sync by adjusting the electronic delay lines. At this stage (Stage 2) the spectrum will be similar to the one shown in FIG. 40(c). The resultant signal is amplified with the help of a semiconductor optical amplifier (SOA) and then sent to a waveshaper. The programmable waveshaper allows the compression of the pulses by de-chirping the input temporal waveform through the application of suitable dispersion. At this stage (Stage 3), the time domain waveform will look like the one shown in FIG. 40(d), where both the compressed pulses as well as the pre-compressed chirped pulses are shown. Finally, the electro-optic frequency comb was characterized in the frequency domain using an optical spectrum analyzer (OSA), and in the time domain using an intensity auto-correlator.

### 3.6.4 Quasi-Sync Pumping

The thresholds of the far non-degenerate OPOs are higher owing to a combination of multiple reasons. The adiabatic coupler is not tailor-designed for each OPO, instead, a uniform coupler has been implemented in this first-generation chip design. As a result, the far non-degenerate operation of the OPOs leads to signals experiencing higher round-trip losses (due to progressively larger out-coupling for smaller wavelengths). Moreover, the effective nonlinear coefficient which takes into consideration the effective area of the modes, and the field overlap between the pump, signal, and idler modes also degrades.

The higher threshold requirement demands more pump power which is currently on the higher side due to the rather high input coupling loss/insertion loss (approximately between 10 to 12 dB). There have been several proposals and demonstrations to bring this number down to a few dBs [54,56]. In the scenario of the availability of low insertion loss, the required external pump power can be dramatically reduced by approximately 10 dB. Under these circumstances, the threshold requirement for far non-degenerate operations can be easily accessible even with sub-optimum design.

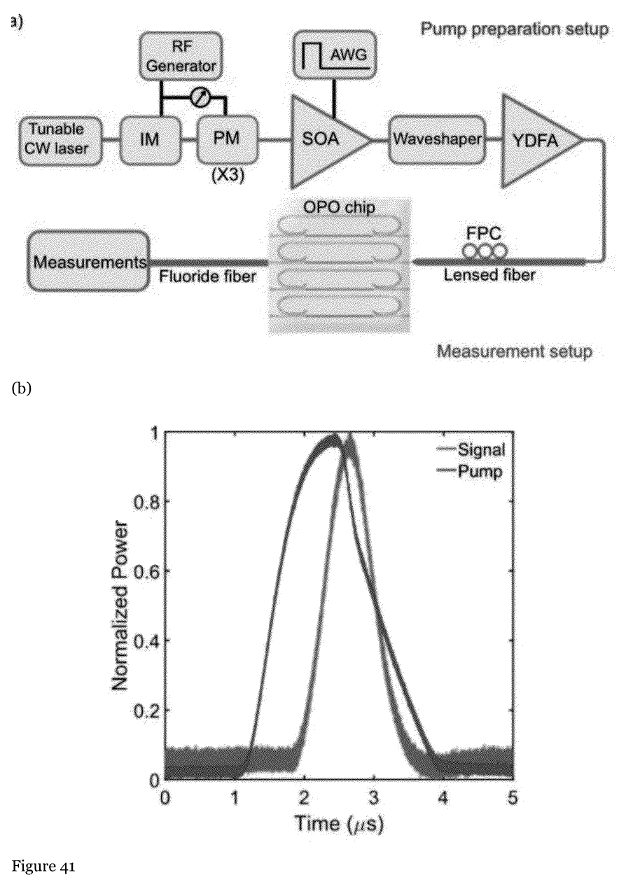

However, in our present implementation, we, unfortunately, do suffer from excess insertion loss, which results in the required off-chip average power exceeding 60 mW. At these power levels, we are prone to burning/damaging the connectors and affecting the YDFA in the presence of undesired back-reflected power. To ensure safe operation we resort to quasi-sync pumping, whereby the average power is reduced by pulsing the pump. This can be achieved by driving the semiconductor optical amplifier (SOA) using an arbitrary waveform generator (AWG) leading to microsecond scale pulses at a repetition rate varying from 1 to 20 KHz (Duty cycle of 1000 to 50). The schematic is shown in FIG. 41(a), which is the same as the pump preparation setup with the addition of an AWG-driven SOA. The time domain traces captured using a slow detector for the pump and signal pulses are shown in FIG. 41(b). We note that the slow detector could not resolve the individual picosecond scale pulses within each quasi-pulse. In fact, there are of the order of thousands of pulses within each quasi-pulse.

### 3.6.5 Estimating the Cavity Free Spectral Range

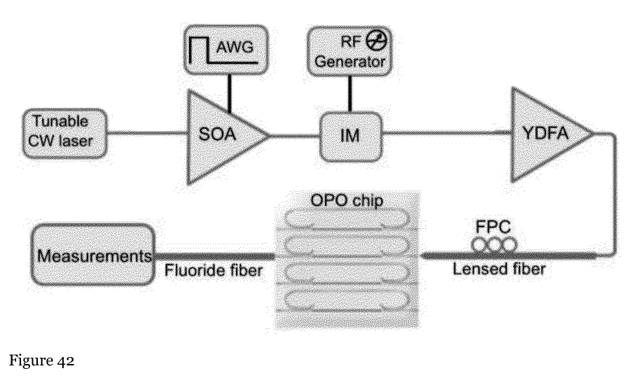

Estimating the free spectral range of the cavity (FSR) is central to determining the repetition rate of the synchronously pumped OPO. This is absolutely necessary since the sync pump (EO comb) cannot be tuned continuously to search for the right FSR. Each setting of the EO comb requires a specific combination of the electronic phase delay line parameters and the waveshaper dispersion parameter, adjusting which is an arduous task. The design of our OPO precludes the use of a tunable CW source around 1 μm to scan through multiple cavity resonances. The situation is exacerbated in the absence of a high-power tunable CW source of around 2 μm at our disposal. Under these circumstances, we estimate the cavity FSR using a measurement setup as shown in FIG. 42.

In this approach, we have to operate the OPO in CW mode. We apply a variable modulation on top of the CW using an intensity modulator (IM). The frequency of modulation is varied using an arbitrary waveform generator. The output of the OPO will be maximized in the vicinity of the correct cavity FSR. This setup unlike the EO comb can be continuously tuned.

### 3.6.6. Spectral Broadening/Pulse Compression in the Degenerate OPO

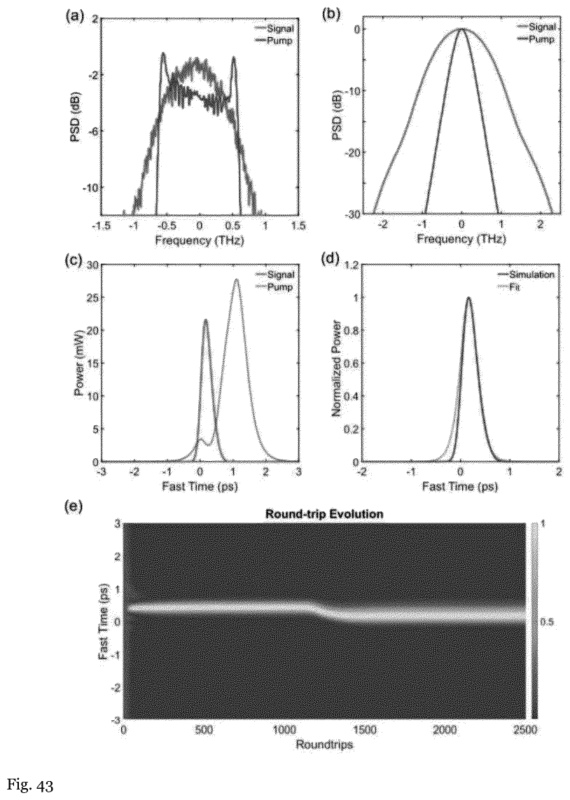

The measured pump pulse width (assuming a Gaussian pulse as extracted from the intensity auto-correlation trace) is ˜1 ps. The estimated transform-limited pulse width for the OPO operating at degeneracy is 380 fs. The experimental spectrum of both the pump and signal are translated in frequency and overlaid on top of each other as shown in FIG. 43(a). The numerical simulation results obtained from a dual envelope equation simulation are shown in FIG. 43(b-e), which closely agrees with the measured data. By proper dispersion engineering (group velocity dispersion and group velocity mismatch) [41], it is possible to generate OPO frequency comb with broad instantaneous bandwidth, leading to few optical cycle pulses.

### 3.6.7 Coherence Verification Using Field Cross-Correlation Technique

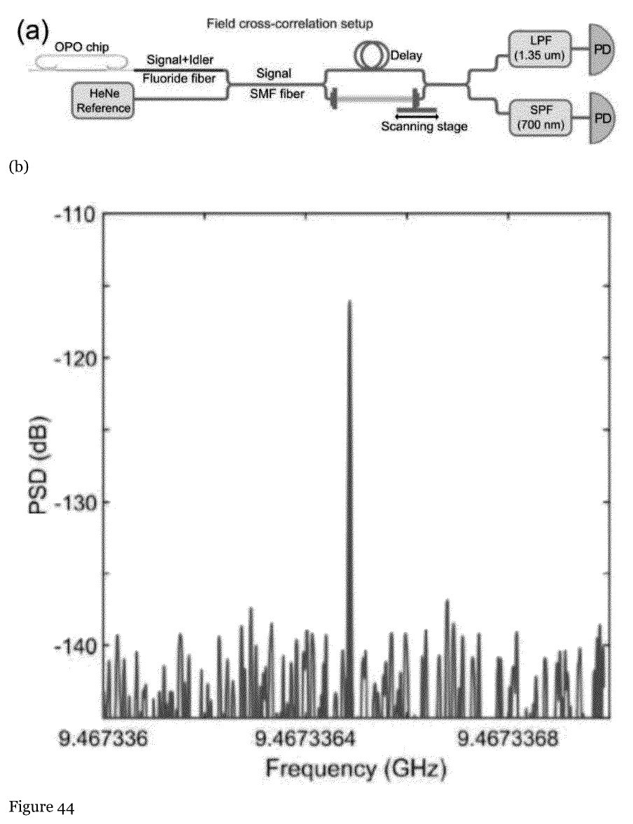

In order to evaluate the coherence of the spectrum, we performed a linear field crosscorrelation (FCCR) of the output signal light, where each OPO pulse was interfered with another pulse delayed by 10 roundtrips. This can be thought of being a modified FTIR measurement, where instead of performing auto-correlation we are executing cross-correlation. The schematic of the setup used for this purpose is shown in FIG. 44(a). The delay line corresponds to a delay of 10 OPO pulses, and thus the coherence property evaluation is limited by the applied delay duration. The scanning stage nonlinearity is corrected using a reference HeNe laser beam. This is important to match the optical spectrum obtained through the optical spectrum analyzer and which is calculated by performing the Fourier transform of the FCCR trace.

We also detect a sharp RF beat-frequency corresponding to the applied repetition rate of the sync-pumped OPO (FIG. 44(b)). The signal is obtained by measuring the OPO output pulses using a fast photo-detector. The pump is rejected using a wavelength de-multiplexer.

### 3.6.8 Full System Integration and a Universal Frequency Comb Source

A complete integrated solution for frequency comb generation can be based on lithium niobate nanophotonics in conjunction with a laser chip. With several design enhancements, it is possible to lower the threshold for frequency comb generation substantially which can allow the pumping with commercially available DFB laser chips. Alternatively, an integrated external cavity along with a semiconductor gain chip can also be deployed for this purpose [28]. The other crucial building blocks are: a) near-IR picosecond pump pulse generation [18, 58], b) Mach Zehnder interferometer mesh for routing the pump light to the desired OPO [51], c) an array of OPOs, and d) periodically poled lithium niobate waveguides supporting ultralow power supercontinuum generation for f-2f based frequency comb stabilization [20,38]. Our present work focuses on part c, while the rest has already been demonstrated in lithium-niobate nanophotonics.

### 3.6.9. Temperature Tuning of the Phase-Matching Curves

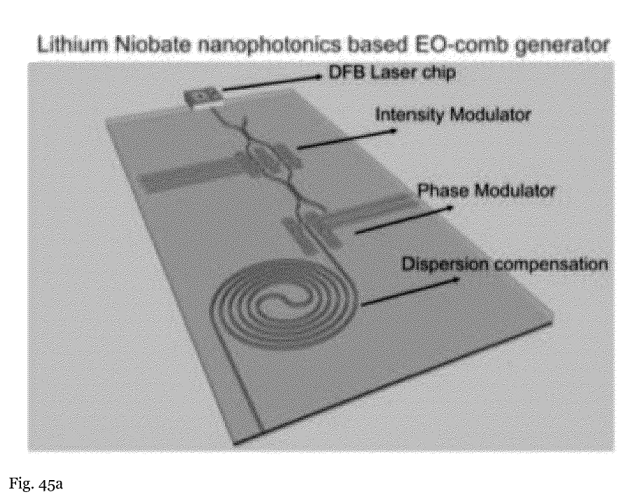

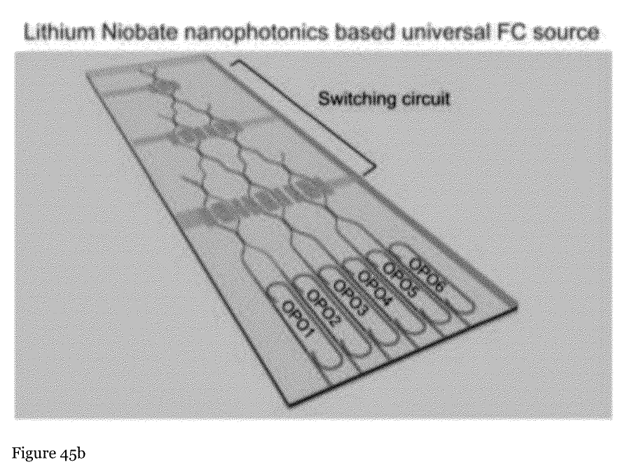

The fine-tuning of the quasi-phase-matching (QPM) in this embodiment has been performed by tuning the pump wavelength. The same can be achieved with the help of temperature tuning while keeping the pump wavelength fixed. FIG. 45 shows the phase-matching curves as a function of temperature which is calculated by evaluating the effective index of the waveguides taking into consideration the temperature-dependent Sellmeier equation [10]. Temperature tuning can either be attained globally by placing the chip on top of a TEC heater element, or locally by implementing resistive heater elements close to the periodically poled regions. We note that the expected tuning curves (obtained from simulations) are more tunable than what is observed in experiments. We anticipate that it may be attributed to the presence of thermal resistance between the heater element and the nanophotonic chip, and/or the mismatch in the thermal expansion coefficients between the insulator layer and the thin-film lithium niobate layer, but can be subject of further investigation.

### References for the Third Embodiment

The following references are incorporated by reference herein.

[1] Florian Adler, Kevin C Cossel, Michael J. Thorpe, Ingmar Hartl, Martin E Fermann, and Jun Ye. Phase-stabilized, 1.5w frequency comb at 2.8-4.8 μm. Optics Letters, 34(9):1330-1332, 2009.

[2] Mark A. Arbore and Martin M. Fejer. Singly resonant optical parametric oscillation in periodically poled lithium niobate waveguides. Optics Letters, 22(3):151-153, 1997.

[3] Alexander W. Bruch, Xianwen Liu, Zheng Gong, Joshua B. Surya, Ming Li, Chang-Ling Zou, and Hong X. Tang. Pockels soliton microcomb. Nature Photonics, 15(1):21-27, 2021.

[4] Ian Coddington, Nathan Newbury, and William Swann. Dual-comb spectroscopy. Optica, 3(4):414-426, 2016.

[5] Matteo Conforti, Fabio Baronio, and Costantino De Angelis. Nonlinear envelope equation for broadband optical pulses in quadratic media. Physical Review A, 81(5):053841, 2010.

[6] Camiel Op de Beeck, Felix M. Mayor, Stijn Cuyvers, Stijn Poelman, Jason F Herrmann, Okan Atalar, Timothy P. McKenna, Bahawal Haq, Wentao Jiang, Jeremy D. Witmer, et al. Iii/v-on-lithium niobate amplifiers and lasers. Optica, 8(10):1288-1289,2021.

[7] Scott A. Diddams, Kerry Vahala, and Thomas Udem. Optical frequency combs: Coherently uniting the electromagnetic spectrum. Science, 369 (6501): eaay 3676,2020.

[8] Majid Ebrahim-Zadeh and Irina T. Sorokina. Mid-infrared coherent sources and applications. Springer Science & Business Media, 2007.

[9] Robert C. Eckardt, C. D. Nabors, William J. Kozlovsky, and Robert L. Byer. Optical parametric oscillator frequency tuning and control. Journal of the Optical Society of America B, 8(3):646-667, 1991.

[10] Ofer Gayer, Z. Sacks, E. Galun, and Ady Arie. Temperature and wavelength dependent refractive index equations for mgo-doped congruent and stoichiometric linbo3. Applied Physics B, 91(2):343-348, 2008.

[11] Austin G. Griffith, Ryan K. W. Lau, Jaime Cardenas, Yoshitomo Okawachi, Aseema Mohanty, Romy Fain, Yoon Ho Daniel Lee, Mengjie Yu, Christopher T. Phare, Carl B. Poitras, et al. Silicon-chip mid-infrared frequency comb generation. Nature Communications, 6(1):1-5, 2015.

[12] Hairun Guo, Clemens Herkommer, Adrien Billat, Davide Grassani, Chuankun Zhang, Martin H. P. Pfeiffer, Wenle Weng, Camille-Sophie Bres, and Tobias J. Kippenberg. Mid-infrared frequency comb via coherent dispersive wave generation in silicon nitride nanophotonic waveguides. Nature Photonics, 12(6):330-335,2018.

[13] Qiushi Guo, Ryoto Sekine, Luis Ledezma, Rajveer Nehra, Devin J. Dean, Arkadev Roy, Robert M. Gray, Saman Jahani, and Alireza Marandi. Femtojoule femtosecond all-optical switching in lithium niobate nanophotonics. Nature Photonics, 16(9):625-631, 2022.

[14] Xiang Guo, Chang-Ling Zou, Hojoong Jung, Zheng Gong, Alexander Bruch, Liang Jiang, and Hong X. Tang. Efficient generation of a near-visible frequency comb via cherenkov-like radiation from a Kerr microcomb. Physical Review Applied, 10:014012, July 2018. doi: 10.1103/PhysRevApplied. 10.014012. URL https://link.aps.org/doi/10.1103/PhysRevApplied. 10.014012.

[15] Ryan Hamerly, Alireza Marandi, Marc Jankowski, Martin M. Fejer, Yoshihisa Yamamoto, and Hideo Mabuchi. Reduced models and design principles for half-harmonic generation in synchronously pumped optical parametric oscillators. Physical Review A, 94(6):063809, 2016.

[16] Yang He, Qi-Fan Yang, Jingwei Ling, Rui Luo, Hanxiao Liang, Mingxiao Li, Boqiang Shen, Heming Wang, Kerry Vahala, and Qiang Lin. Self-starting bi-chromatic linbo 3 soliton microcomb. Optica, 6(9):1138-1144, 2019.

[17] Changran Hu, An Pan, Tingan Li, Xuanhao Wang, Yuheng Liu, Shiqi Tao, Cheng Zeng, and Jinsong Xia. High-efficient coupler for thin-film lithium niobate waveguide devices. Optics Express, 29(4):5397-5406, 2021.

[18] Yaowen Hu, Mengjie Yu, Brandon Buscaino, Neil Sinclair, Di Zhu, Rebecca Cheng, Amirhassan Shams-Ansari, Linbo Shao, Mian Zhang, Joseph M. Kahn, et al. High-efficiency and broadband on-chip electro-optic frequency comb generators. Nature Photonics, 16(10):679-685, 2022.

[19] Andreas Hugi, Gustavo Villares, Stéphane Blaser, H. C. Liu, and Jérôme Faist. Mid-infrared frequency comb based on a quantum cascade laser. Nature, 492(7428):229-233,2012.

[20] Marc Jankowski, Carsten Langrock, Boris Desiatov, Alireza Marandi, Cheng Wang, Mian Zhang, Christopher R. Phillips, Marko Lončar, and Martin M. Fejer. Ultrabroadband nonlinear optics in nanophotonic periodically poled lithium niobate waveguides. Optica, 7(1):40-46, 2020.

[21] Xingchen Ji, Xinwen Yao, Alexander Klenner, Yu Gan, Alexander L. Gaeta, Christine P. Hendon, and Michal Lipson. Chip-based frequency comb sources for optical coherence tomography. Optics Express, 27(14):19896-19905, 2019.

[22] Tobias J. Kippenberg, Alexander L. Gaeta, Michal Lipson, and Michael L. Gorodetsky. Dissipative Kerr solitons in optical microresonators. Science, 361(6402):eaan8083, 2018.

[23] Abijith S. Kowligy, David R. Carlson, Daniel D. Hickstein, Henry Timmers, Alexander J. Lind, Peter G. Schunemann, Scott B. Papp, and Scott A. Diddams. Mid-infrared frequency combs at 10 ghz. Optics Letters, 45(13):3677-3680, 2020.

[24] Luis Ledezma, Arkadev Roy, Luis Costa, Ryoto Sekine, Robert Gray, Qiushi Guo, Ryan M Briggs, and Alireza Marandi. Widely-tunable optical parametric oscillator in lithium niobate nanophotonics. arXiv preprint arXiv: 2203.11482, 2022.

[25] Luis Ledezma, Ryoto Sekine, Qiushi Guo, Rajveer Nehra, Saman Jahani, and Alireza Marandi. Intense optical parametric amplification in dispersionengineered nanophotonic lithium niobate waveguides. Optica, 9(3):303-308, 2022.

[26] Hansuek Lee, Tong Chen, Jiang Li, Oskar Painter, and Kerry J. Vahala. Ultralow-loss optical delay line on a silicon chip. Nature Communications, 3 (1):1-7,2012.

[27] Jiang Li, Chengying Bao, Qing-Xin Ji, Heming Wang, Lue Wu, Stephanie Leifer, Charles Beichman, and Kerry Vahala. Efficiency of pulse pumped soliton microcombs. Optica, 9(2): 231-239, 2022.

[28] Mingxiao Li, Lin Chang, Lue Wu, Jeremy Staffa, Jingwei Ling, Usman A. Javid, Shixin Xue, Yang He, Raymond Lopez-Rios, Morin, et al. Integrated pockels laser. Nature Communications, 13(1):1-10, 2022.

[29] Juanjuan Lu, Ayed Al Sayem, Zheng Gong, Joshua B. Surya, Chang-Ling Zou, and Hong X. Tang. Ultralow-threshold thin-film lithium niobate optical parametric oscillator. Optica, 8(4):539-544, 2021.

[30] Xiyuan Lu, Gregory Moille, Ashutosh Rao, Daron A. Westly, and Kartik Srinivasan. On-chip optical parametric oscillation into the visible: Generating red, orange, yellow, and green from a near-infrared pump. Optica, 7(10):1417-1425,2020.

[31] Luke Maidment, Peter G. Schunemann, and Derryck T. Reid. Molecular fingerprint-region spectroscopy from 5 to 12 μm using an orientation-patterned gallium phosphide optical parametric oscillator. Optics Letters, 41(18):42614264, 2016.

[32] Pablo Marin-Palomo, Juned N. Kemal, Maxim Karpov, Arne Kordts, Joerg Pfeifle, Martin H. P. Pfeiffer, Philipp Trocha, Stefan Wolf, Victor Brasch, Miles H. Anderson, et al. Microresonator-based solitons for massively parallel coherent optical communications. Nature, 546(7657):274-279, 2017.

[33] Andrew J. Metcalf, Connor D. Fredrick, Ryan C. Terrien, Scott B. Papp, and Scott A. Diddams. 30 ghz electro-optic frequency comb spanning 300 thz in the near infrared and visible. Optics Letters, 44(11):2673-2676, 2019.

[34] Jatadhari Mishra, Timothy P. McKenna, Edwin Ng, Hubert S. Stokowski, Marc Jankowski, Carsten Langrock, David Heydari, Hideo Mabuchi, Martin M. Fejer, and Amir H. Safavi-Naeini. Mid-infrared nonlinear optics in thin-film lithium niobate on sapphire. Optica, 8(6):921-924, 2021.

[35] Sean Molesky, Zin Lin, Alexander Y. Piggott, Weiliang Jin, Jelena Vucković, and Alejandro W. Rodriguez. Inverse design in nanophotonics. Nature Photonics, 12(11):659-670, 2018.

[36] Ewelina Obrzud, Steve Lecomte, and Tobias Herr. Temporal solitons in microresonators driven by optical pulses. Nature Photonics, 11(9):600-607, 2017.

[37] Ewelina Obrzud, Monica Rainer, Avet Harutyunyan, Miles H. Anderson, Junqiu Liu, Michael Geiselmann, Bruno Chazelas, Stefan Kundermann, Steve Lecomte, Massimo Cecconi, et al. A microphotonic astrocomb. Nature Photonics, 13(1):31-35, 2019.

[38] Yoshitomo Okawachi, Mengjie Yu, Boris Desiatov, Bok Young Kim, Tobias Hansson, Marko Lončar, and Alexander L. Gaeta. Chip-based self-referencing using integrated lithium niobate waveguides. Optica, 7(6):702-707, 2020.

[39] Alexandre Parriaux, Kamal Hammani, and Guy Millot. Electro-optic frequency combs. Advances in Optics and Photonics, 12(1):223-287, 2020.

[40] Arkadev Roy, Saman Jahani, Carsten Langrock, Martin Fejer, and Alireza Marandi. Spectral phase transitions in optical parametric oscillators. Nature Communications, 12(1):1-9, 2021.

[41] Arkadev Roy, Rajveer Nehra, Saman Jahani, Luis Ledezma, Carsten Langrock, Martin Fejer, and Alireza Marandi. Temporal walk-off induced dissipative quadratic solitons. Nature Photonics, 16(2):162-168, 2022.

[42] Anatoliy A. Savchenkov, Vladimir S. Ilchenko, Fabio Di Teodoro, Paul M. Belden, William T. Lotshaw, Andrey B. Matsko, and Lute Maleki. Generation of Kerr combs centered at 4.5 μm in crystalline microresonators pumped with quantum-cascade lasers. Optics Letters, 40(15):3468-3471, 2015.

[43] Albert Schliesser, Nathalie Picqué, and Theodor W. Hänsch. Mid-infrared frequency combs. Nature Photonics, 6(7):440-449, 2012.

[44] Brian Stern, Xingchen Ji, Yoshitomo Okawachi, Alexander L. Gaeta, and Michal Lipson. Battery-operated integrated frequency comb generator. Nature, 562(7727):401-405, 2018.

[45] Liron Stern, Jordan R. Stone, Songbai Kang, Daniel C. Cole, MyoungGyun Suh, Connor Fredrick, Zachary Newman, Kerry Vahala, John Kitching, Scott A. Diddams, et al. Direct Kerr frequency comb atomic spectroscopy and stabilization. Science Advances, 6(9):eaax6230, 2020.

[46] Myoung-Gyun Suh and Kerry J. Vahala. Soliton microcomb range measurement. Science, 359(6378):884-887, 2018.

[47] Myoung-Gyun Suh, Xu Yi, Yu-Hung Lai, Stephanie Leifer, Ivan S. Grudinin, Gautam Vasisht, Emily C. Martin, Michael P. Fitzgerald, Greg Doppmann, Ji Wang, et al. Searching for exoplanets using a microresonator astrocomb. Nature Photonics, 13(1):25-30, 2019.

[48] Yuxing Tang, Logan G. Wright, Kriti Charan, Tianyu Wang, Chris Xu, and Frank W. Wise. Generation of intense 100 fs solitons tunable from 2 to 4.3 μm in fluoride fiber. Optica, 3(9):948-951, 2016.

[49] Philipp Trocha, Maxim Karpov, Denis Ganin, Martin H. P. Pfeiffer, Arne Kordts, Stefan Wolf, Jonas Krockenberger, Pablo Marin-Palomo, Claudius Weimann, Sebastian Randel, et al. Ultrafast optical ranging using microresonator soliton frequency combs. Science, 359(6378):887-891, 2018.

[50] Paul A. Verrinder, Lei Wang, Joseph Fridlander, Fengqiao Sang, Victoria Rosborough, Michael Nickerson, Guangning Yang, Mark Stephen, Larry Coldren, and Jonathan Klamkin. Gallium arsenide photonic integrated circuit platform for tunable laser applications. IEEE Journal of Selected Topics in Quantum Electronics, 28(1):1-9, 2021.

[51] Cheng Wang, Mian Zhang, Xi Chen, Maxime Bertrand, Amirhassan ShamsAnsari, Sethumadhavan Chandrasekhar, Peter Winzer, and Marko Lončar. Integrated lithium niobate electro-optic modulators operating at cmoscompatible voltages. Nature, 562(7725):101-104, 2018.

[52] Christine Y. Wang, Lyuba Kuznetsova, Vasileios-Marios Gkortsas, Laurent Diehl, Franz X. Kaertner, Mikhail A. Belkin, Alexey Belyanin, Xiaofeng Li, Donhee Ham, Harald Schneider, et al. Mode-locked pulses from mid-infrared quantum cascade lasers. Optics Express, 17(15):12929-12943, 2009.

[53] Xingyuan Xu, Mengxi Tan, Bill Corcoran, Jiayang Wu, Andreas Boes, Thach G. Nguyen, Sai T. Chu, Brent E. Little, Damien G. Hicks, Roberto Morandotti, et al. 11 tops photonic convolutional accelerator for optical neural networks. Nature, 589(7840):44-51, 2021.

[54] Ni Yao, Junxia Zhou, Renhong Gao, Jintian Lin, Min Wang, Ya Cheng, Wei Fang, and Limin Tong. Efficient light coupling between an ultra-low loss lithium niobate waveguide and an adiabatically tapered single mode optical fiber. Optics Express, 28(8):12416-12423, 2020.

[55] Yu Yao, Anthony J. Hoffman, and Claire F. Gmachl. Mid-infrared quantum cascade lasers. Nature Photonics, 6(7):432-439, 2012.

[56] Pan Ying, Heyun Tan, Junwei Zhang, Mingbo He, Mengyue Xu, Xiaoyue Liu, Renyou Ge, Yuntao Zhu, Chuan Liu, and Xinlun Cai. Low-loss edge-coupling thin-film lithium niobate modulator with an efficient phase shifter. Optics Letters, 46(6):1478-1481, 2021.

[57] Mengjie Yu, Yoshitomo Okawachi, Austin G. Griffith, Michal Lipson, and Alexander L Gaeta. Mode-locked mid-infrared frequency combs in a silicon microresonator. Optica, 3(8):854-860, 2016.

[58] Mengjie Yu, Christian Reimer, David Barton, Prashanta Kharel, Rebecca Cheng, Lingyan He, Linbo Shao, Di Zhu, Yaowen Hu, Grant, et al. Femtosecond pulse generation via an integrated electro-optic time lens. arXiv preprint arXiv:2112.09204, 2021.

[59] Mian Zhang, Brandon Buscaino, Cheng Wang, Amirhassan Shams-Ansari, Christian Reimer, Rongrong Zhu, Joseph M Kahn, and Marko Lončar. Broadband electro-optic frequency comb generation in a lithium niobate microring resonator. Nature, 568(7752):373-377, 2019.

[60] Further information on one or more embodiments of the invention can be found in Visible-to-mid-IR tunable frequency comb in nanophotonics by Arkadev Roy et. al, Nature Communications volume 14, Article number: 6549 (2023) and supporting information. https://www.nature.com/articles/s41467-023-42289-0

### Fourth Embodiment 40-Pulse Time-Multiplexed NanophotonicOptical Parametric Oscillator

Time-multiplexed systems have become ubiquitous in many subfields of optics, as they offer the ability to create large-scale graphs through the storage of information across distinct temporal bins. As such, they have found applications in areas such as computing, quantum information, and study of topological phenomena [1-3]. Time multiplexed networks of optical parametric oscillators (OPOs), and specifically OPOs at degeneracy, have been of particular interest due to their ability to approximate the Ising Hamiltonian [4,5]. Recent advances in thin-film lithium niobate, including demonstrations of extremely high parametric gains [6] and subsequent demonstrations of optical parametric oscillation [7], bring the possibility of achieving such time-multiplexed systems to a chip scale. Here, we demonstrate an on-chip, 40-pulse, time-multiplexed OPO. Through the use of interferometric techniques, we verified the independence of each of the 40 simultaneously oscillating pulses. This work represents a critical milestone in the path towards creating large-scale graphs in an integrated photonic platform.

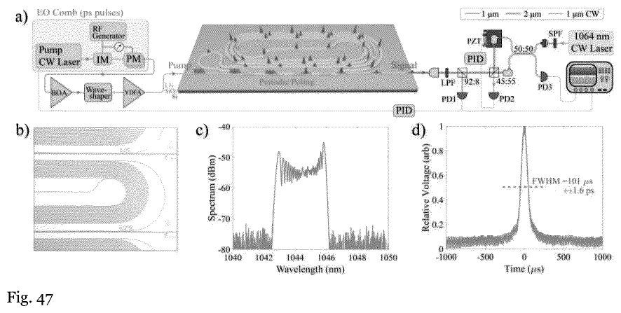

The experimental setup is schematically depicted in FIG. 47. We used an electro-optic (EO) comb (FIG. 1a, left) with a 10 GHz repetition rate to pump the 250 MHz on-chip optical parametric oscillator such that 40 pulses resonate in the cavity. Following the EO comb generation, our pump preparation included a booster optical amplifier (BOA), waveshaper, and Ytterbium-doped fiber amplifier (YDFA) for amplification and dispersion compensation. The pump was characterized by its spectrum (FIG. 47c) and intensity autocorrelation (FIG. 47d), demonstrating over 3 nm of bandwidth around a center wavelength of 1045 nm and an autocorrelation width of 1.6 ps. Periodic poling on the waveguide (FIG. 47a, center) provided phase matching between the pump and the signal around 2090 nm. Tapered couplers ensured coupling of the signal to the resonator while allowing the pump to pass through. An optical microscope image highlighting the 53-cm spiral resonator is shown in FIG. 47b.

We characterized the relative phases of the output pulses using an unbalanced (1-pulse delayed) MachZehnder interferometer (MZI) consisting of a 45:55 free-space pellicle beam-splitter and a 50:50 fiber splitter (FIG. 47a, right). One of the free-space arms had a delay stage which can be locked using a piezoelectric transducer (PZT) to the signal from a back-propagating CW laser at 1064 nm coupled through one MZI output port and measured on a photodetector (PD2). Using this 100-ps delay, we interfered consecutive pulses in the 10-GHz pulse train. A 1-MHz photodetector (PD3) at the other MZI output measured the average value of these interferences over many pulses. If the phases of the 40 pulses are random and independent of one another, we expected to see a different average interference value for every instance of the OPO. To measure this, we modulated the BOA in the pump preparation setup to carve out 4 μs pulses at a repetition rate of 10 kHz on top of the 10 GHz comb. This served to rapidly turn the OPO on and off. We additionally use a 92:8 pellicle at the output of the chip to continuously monitor the MZI input on PD1 for both referencing the measurement and pump stabilization.

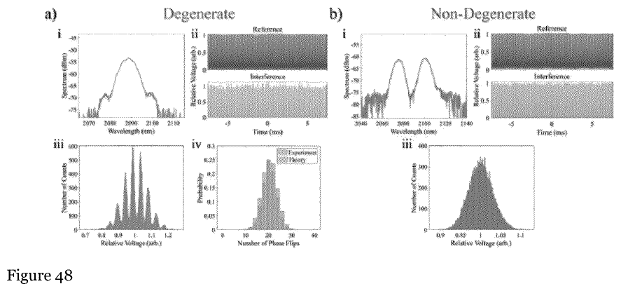

FIG. 48a shows the experimental results in the case of degeneracy, where oscillation occurs at the halfharmonic of the pump, as confirmed in the measured optical spectrum (i). Here, the OPO was expected to oscillate in only two phase states, 0 or π. With 40 pulses, the average value of the resulting interference should have only 21 possible allowed levels. The probability of each level is given by

$$\frac{1}{{2}^{3 {3}^{9}} * ( \frac{40}{N} )} ,$$

where N is the number of phase flips that occur in the string of 40 pulses. In sub-figure (ii), a sample train of OPO instances is shown. The reference trace collected from the 8:92 splitter allows for post-correction of the measured data to account for intensity noise in the OPO output. The time trace from the interference, shown in the lower panel, shows significantly larger fluctuations than the reference, as expected. A histogram of the interference output over a measurement time of 2 s is shown in (iii). Here, the expected discrete states are clearly observed, indicating that the 40 pulses are in fact behaving as independent, time-multiplexed degenerate OPOs with random binary phases. In addition, we can use the histogram from (iii) to compute a probability mass function and compare it with the theoretical probabilities. The result (iv) shows good agreement between the experiment and theory.

We also measured the case of non-degenerate oscillation, as illustrated in FIG. 48b. Here, the optical spectrum indicates distinct signal and idler modes (i). As in the degenerate case, a sample of the time trace data (ii) shows larger fluctuations for the interferences than for the reference measurement. However, unlike the degenerate case, the phase of the non-degenerate OPO is not constrained to discrete levels but can take on any level. Thus, we expect to see a continuous, Gaussian distribution in the histogram, as observed in (iii).

In conclusion, we demonstrated a 40-pulse, time-multiplexed, nanophotonic optical parametric oscillator operating in both the degenerate and non-degenerate regimes. Through measurement of the average interference between consecutive pulses for many instances of the OPO, we have shown the independence of all 40 pulses. This result paves the way for implementing on-chip, optical timemultiplexed systems such as Ising machines.

### References for the Fourth Embodiment

The following references are incorporated by reference herein.
1. C. Leefmans et al., Nat. Phys. 18, 442-449 (2022).
2. S. Yokoyama et al., Nat. Photonics 7, 982-986 (2013).
3. R. Nehra et al., Science 377, 1333-1337 (2022).
4. A. Marandi et al., Nat. Photonics 8, 937-942 (2014).
5. N. Mohseni et al., Nat. Rev. Phys. 4, 363-379 (2022).
6. L. Ledezma et al., Optica 9, 303-308 (2022).
7. L. Ledezma et al., arXiv preprint, arXiv: 2203.11482 (2022).

### Example Pumping Sub Circuits

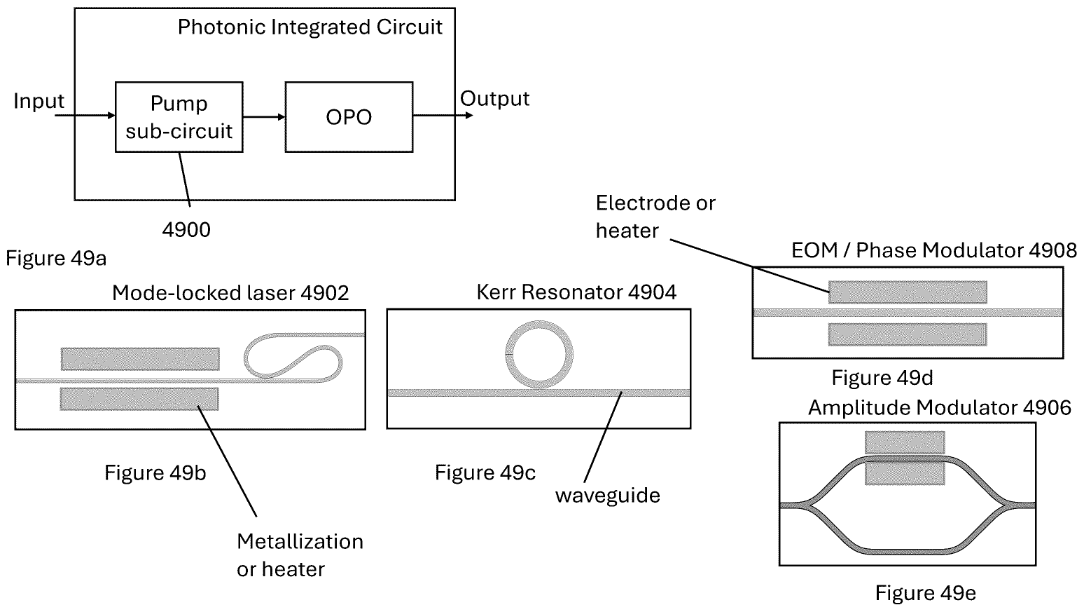

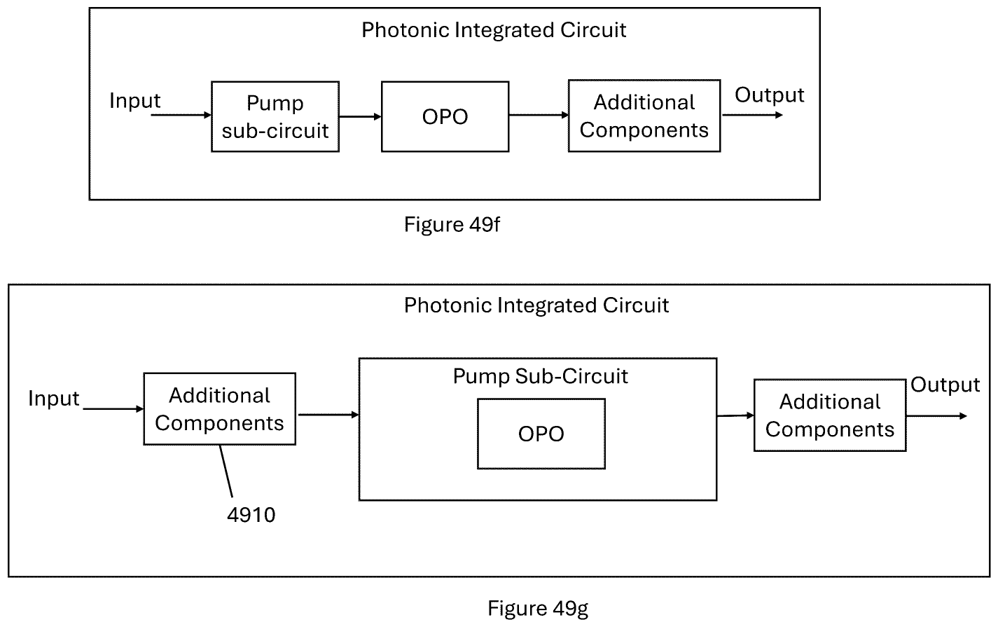

FIG. 49a illustrates the photonic integrated circuit can include a pumping sub-circuit coupled to the OPO. FIG. 49b illustrates an example wherein the pumping sub-circuit comprises a mode locked laser comprising a modulator (e.g., electro-optic modulator) comprising electrode metallization or heater coupled to a waveguide. FIG. 48c illustrates an example wherein the pumping sub-circuit comprises a Kerr resonator. FIG. 48d illustrates an example wherein the pumping sub-circuit comprises an electro-optic (EOM) modulator/phase modulator (e.g. comprising electrodes coupled to a waveguide section). FIG. 48e illustrates an example wherein the pumping sub-circuit comprises an amplitude modulator (e.g., comprising electrode coupled to a waveguide section). In one or more embodiments, the Kerr resonator (e.g., comprising a loop) comprises a Kerr nonlinearity, i.e. is not linear.

FIG. 49f illustrates an example of the device wherein the OPO can be inside an integrated laser cavity and FIG. 49g illustrates an example wherein the OPO includes a laser gain element or wherein the pump pulses or frequency comb are created inside the resonator.

FIG. 49f-g illustrate the device of clause 1, wherein the circuit comprises additional components at the output of the OPO including nonlinear components 4910 for wavelength conversion, nonlinear components 4910 for spectral broadening, Linear components such as filters and couplers, Actuators such as electro-optic modulators.

### Process Steps

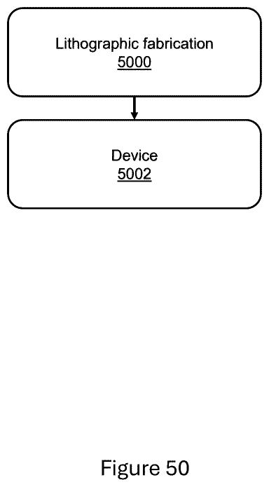

FIG. 50 is a flowchart illustrating a method of making a device according to one or more embodiments.

Block 5000 represents using lithographic patterning of a substate to form a photonic integrated circuit comprising the OPOs comprising one or more waveguides comprising the nonlinear material outputting a wave (signal and/or an idler) in response to a pump wave using a parametric nonlinear process. The waveguides each have a width and height of less than 5 micrometers. The nonlinear materials are phase matched and dispersion engineered to control appropriate group velocity mismatch (GVM) between pump and signal pulses so as to provide temporal overlap of the pump and signal/idler pulses. In one or more examples, the, waveguides have the length appropriately tailored for the dispersion engineering. Example nonlinear materials having the (e.g., second order) nonlinearity (and which can form the substrate chip), include but are not limited to, lithium niobate, lithium tantalate, Potassium Titanyl Phosphate (KTP), aluminum nitride, gallium arsenide, indium phosphide, aluminum gallium arsenide, GaP, or InGaP. The invention is not limited to second order nonlinearity, other non linear materials can be used, including, but not limited to, third-order nonlinear materials, such as SiN and Si, can be used. In one or more examples, the substrate comprises lithium niobate on silicon dioxide, and the waveguides are patterned in the lithium niobate (monolithic integration of the waveguides). Other components such as a pump laser, injection locking input, or auxiliary resonators can be patterned in the same substrate or on a different material substrate bonded to the substrate containing the OPO.

Actuators (e.g., electro-optic modulator, an electric heater, a thermo-optical heater, or a piezoelectric transducer, e.g., to modulate phase or amplitude of waves or refractive index of the using electric field or temperature) can be fabricated by depositing metallization coupled to the waveguides formed in lithium niobate/substrate.

The input to, and the output from, each of the OPOs can comprise an input coupler and the output coupler, respectively, which can be integrated in the device. The input coupler and the output coupler may comprise an adiabatic coupler, a directional coupler, a Y-junction, a multi-mode interferometer, or an inverse-designed coupler which can be formed, for example, by etching appropriate combination of waveguides into the substrate (comprising the nonlinear material such as lithium niobate.

In one or more examples, the photonic integrated circuit includes or is coupled to sub-circuit for the pump, e.g., wherein the sub-circuit is configured to output the pump wave comprising the pulses or the frequency comb with the pump repetition rate. The sub-circuit can be formed in the substrate comprising the nonlinear material, or a different substrate chip. In one or more examples, the Kerr frequency comb is fabricated by forming a loop waveguide coupled by a gap to a linear section of a waveguide, as illustrated in FIG. 49.

In yet further examples, the sub-circuit comprises one or more actuators operable to adjust at least one of the repetition rate, a carrier envelope offset, an intensity, or a wavelength of the pump wave. In one or more examples, the actuators are formed by depositing metallization coupled to a waveguide formed in the substrate (e.g., comprising a nonlinear material such as lithium niobate). In one or more examples, the sub-circuit comprises at least one of a mode-locked laser, an electro-optic frequency comb source, a Kerr frequency comb source, an amplitude modulator, or a phase modulator. In one or more examples, the electro-optic comb source can includes a modulator which can be realized by depositing metal on lithium niobate (or nonlinear material) or on a thin layer of dielectric deposited on lithium niobate (or non linear material). In one or more embodiments, the amplitude modulator or the phase modulator can comprise the metal deposited on top of an additional dielectric layer on LN.

In yet further examples, the photonic integrated circuit comprises additional components at the output of the OPO including nonlinear components for wavelength conversion, nonlinear components for spectral broadening, linear components such as filters and couplers, actuators such as electro-optic modulators. Example nonlinear components include, but not limited to, her OPOS or other, nonlinear waveguides or amplifiers in; the nonlinear material of the substrate (e.g., lithium niobate) that do frequency mixing, harmonic generation (e.g., SHG), or parametric amplification processes.

In one or more embodiments, the OPO comprises multiple sections as well as having quasi-phase matching in an on-chip sync-pumped OPO. Phase matching can be achieved with other techniques such as modal phase matching as well.

In one or more examples, dispersion engineering comprises making a specific cross-section geometry to provide proper group-velocity dispersion (like FIG. 5 or FIG. 30b).

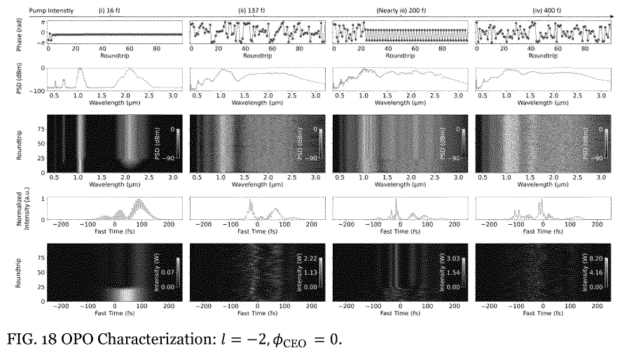

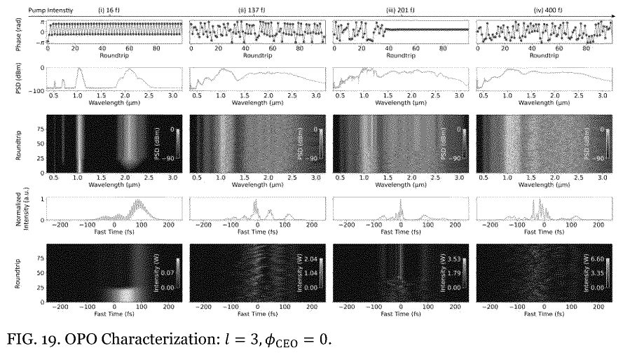

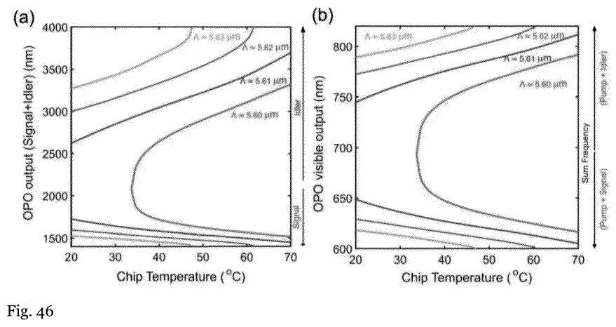

Block 5002 represents the end result, a device, system or apparatus. The device can be embodied in many ways including, but not limited to, the following (referring also to FIGS. 1-48)

1. A device, system, or apparatus 100, 3100 comprising:
a photonic integrated circuit 102, 3102 comprising one or more optical parametric oscillators (OPOs) 104 each comprising:
an input 106, 3106, configured to receive a pump wave 3108 (arrow 108 shows direction of pump wave) comprising pulses or a frequency comb with a pump repetition rate,
one or a plurality of nonlinear sections 110, 3110 as part of a resonator 3112, 112 (comprising waveguide 113, 3113) or coupled to a resonator having a free spectral range, where at least one of the free spectral range or one of its harmonics (e.g., harmonics of the spectral range) is matched to (e.g., equal to, or within 10% of) at least one of the pump repetition rate or its harmonics, and
one or a plurality of outputs 114, 3114 configured to extract a portion of the waves (arrow 118 shows direction of extracted waves) generated by the OPO in response to the pump wave and/or extract the pump wave (e.g., for other uses).

2. The device of clause 1, wherein each of the nonlinear sections are phase matched for one or a plurality of nonlinear optical processes including degenerate optical parametric amplification, non-degenerate optical parametric amplification, up-conversion of the waves in the OPO, down-conversion of the waves in the OPO, spectral broadening of the waves in the OPO. In one or more examples, the non linear waveguide can have different sections that are each phase matched for different nonlinear processes, or nonlinear sections in different OPOs are phased matched for different nonlinear processes.

3. The device of clause 2, wherein the phase matching is achieved through quasi-phase matching, for instance through periodic or aperiodic poling.

4. The device of clause 1 or 2, wherein the nonlinear section and/or other parts of the resonator (e.g., waveguide forming the resonator) is dispersion engineered to adjust the spectrum of one or a plurality of the waves generated in the OPO. In one or more examples, adjusting the spectrum refers to how the GVD and GVM can change the parametric gain as an example, as shown in FIG. 1c.

5 The device of any of the clauses 1-4, wherein the dispersion engineered OPO supports formation of temporal solitons. Temporal solitons are the specific type of nonlinear operation. An example of a design to support solitons is shown in FIG. 30a,b.

6. The device of any of the clauses 1-5, wherein the photonic integrated circuit further comprises one or more actuators 4906 for modulating and/or adjusting one or a plurality of:
a phase matching condition of the nonlinear sections,
the center frequency of the portion of the wave comprising an output wave,
the carrier-envelope offset frequency of the output waves,
the free-spectral range of the resonator,
the spectral response of resonator.

7. The device of clause 6, wherein the actuators can each independently comprise an electro-optic modulator, an electric heater, a thermo-optical heater, or a piezoelectric transducer.

8 The device of any of the clauses 1-7, comprising a plurality of OPOs, wherein each of the OPOs comprise the nonlinear sections with different phase matchings, e.g., for different nonlinear processes. In one or more embodiments, different OPOs have different phase matchings. In yet further embodiments, each of the OPOs have sections with different phase matchings or a range of different phase matchings.

9 The device of any of the clauses 1-8, wherein the photonic integrated circuit further comprises:
a switching circuit (e.g., a Mach Zehnder Interferometer (MZI) or plurality of, or a network of MZI) configured to selectively route the pump wave to different ones of the OPOs, so that the outputs of the OPOs, independently or in combination, comprise outputs ranging from ultraviolet to mid infrared wavelengths.

10. The device of any of the clauses 1-9, wherein the photonic integrated circuit comprises an integrated input coupler 3106, and the output comprises an integrated output coupler 3114, e.g., but not limited to, wherein the input coupler and/or the output coupler is coupled by a gap to the OPO's waveguide.

11. The device of any of the clauses 1-10, wherein the input coupler and the output coupler each independently comprise an adiabatic coupler 3106, a directional coupler, a Y-junction, a multi-mode interferometer, or an inverse-designed coupler.

12. The device of any of the clauses 1-11, wherein the resonator comprises a spiral resonator or a resonator having a length of at least 10 centimeters.

13. The device of any of the clauses 1-12, wherein the output bandwidth is at least a factor of 2 broader than the input bandwidth of the pump input in hertz units.

14. FIG. 49a illustrates an example of the device of clause 1, wherein the photonic integrated circuit includes a sub-circuit 4900 for the pump, e.g., wherein the sub-circuit is configured to output the pump wave comprising the pulses or the frequency comb with the pump repetition rate.

15. FIG. 49b-e illustrate examples of the device of clause 14, wherein the sub-circuit comprises at least one of a mode-locked laser 4902, an electro-optic frequency comb source, a Kerr frequency comb source 4904, an amplitude modulator 4906, or a phase modulator 4908.

16. FIG. 49b-e The device of clause 14, wherein the sub-circuit comprises one or more actuators 4906 operable to adjust at least one of the repetition rate, a carrier envelope offset, an intensity, or a wavelength of the pump wave.

17. The device of any of the clauses 1-16, wherein the pump pulses have lengths in a range of 1-100 picoseconds and the OPO generates pulses shorter than 1 picosecond.

18. FIG. 49f illustrates an example of the device of any of the clauses 1-17, wherein the OPO is inside an integrated laser cavity or the OPO includes a laser gain element.

19. The device of any of the clauses 1-18, wherein the pump pulses or frequency comb are created inside the resonator.

20. The device of any of the clauses 1-19, wherein the pump frequency comb does not constitute pulses in the time domain or comprises a continuous wave frequency modulated wave.

21. FIG. 49f-g illustrate the device of any of the clauses 1-20, wherein the circuit comprises additional components at the output of the OPO including:
Nonlinear components 4910 for wavelength conversion,
Nonlinear components 4910 for spectral broadening,
Linear components such as filters and couplers,
Actuators such as electro-optic modulators.

22. A computing system, metrology system, or communication system comprising the device of any of the clauses 1-21.

23. The device of any of the clauses 1-22, wherein each of the OPOs:
comprises the resonator comprising a waveguide coupled to the nonlinear sections, and the waveguide and the nonlinear sections are dispersion engineered with a geometry (e.g., cross-section geometry that defines the dispersion) selected so the pump wave, and the waves generated in the OPO comprising a spectrum centered around the half harmonic of the pump, experience near zero group velocity mismatch (e.g., less than 20% of that of the bulk material at the same wavelength) and have near zero group velocity dispersion (e.g., less than 20% of that of the bulk material at the same wavelength) such that the pulses of the pump wave and the waves comprising the half harmonic completely (or at least 90%) overlap (temporal envelope of the half harmonic wave is completely within or at least 90% overlaps the temporal envelope of the pump wave), the nonlinear sections are phase matched for degenerate operation of the OPO wherein the nonlinear process converts the pump wave into the wave comprising the half harmonic; and the input and output each comprise a coupler designed as frequency selective coupler to only allow resonance around the half-harmonic.

24. The device of clause 23, wherein the couplers each comprise an input waveguide separated by a gap from a section of the OPO waveguide, each of the input waveguide and the section of the OPO waveguide having a width varying gradually along its length, so that the input couples the pump wave into the cavity and the output coupler couples the half harmonic or the signal comprising output frequency comb out of the cavity.

25. The device of clause 23, wherein the pump has an energy above a value that transitions the OPO from an incoherent operation regime, typical for operation far (more than 5 times) above its oscillation threshold, to an ultrabroad coherent regime, allowing generation of an output frequency comb comprising a multi octave coherent spectrum.

26. The device of any of the clauses 1-22, wherein each of the OPOs:
comprise the resonator comprising a waveguide coupled to the nonlinear sections, and the waveguide and the nonlinear sections are dispersion engineered with a selected geometry so the pump wave, and the waves generated in the OPO comprising a signal or idler wave, experience near zero group velocity mismatch (e.g., less than 20% of that of the bulk material at the same wavelength) and have near zero group velocity dispersion (e.g., less than 20% of that of the bulk material at the same wavelength) such that the pulses of the pump wave and the signal or idler completely or at least 90% overlap (temporal envelope of the signal wave is completely within or at least 90% overlaps with the temporal envelope of the pump wave),
the nonlinear sections are phase matched for degenerate, non-degenerate, frequency up conversion or frequency down conversion operation of the OPO wherein the nonlinear process converts the pump wave into the signal and/or the idler; and
the input and output each comprise an adiabatic coupler designed as frequency selective couplers to only allow resonance of the waves generating an output frequency comb having a wavelength range between ultraviolet and midinfrared and extracted by the output.

27. The device of clause 26, wherein the adiabatic couplers each comprise an input waveguide separated by a gap from a section of the OPO waveguide, each of the input waveguide and the section of the OPO waveguide having a width varying gradually along its length and a phase mismatch, so that the input couples the pump wave into the cavity and the output coupler only couples the half harmonic or the signal comprising output frequency comb out of the cavity.

28. The device of any of the clauses 1-27, wherein the resonator comprises a waveguide bounded by reflectors 3106, 3114 (e.g., couplers) or mirrors (e.g., couplers) to form a cavity.

31. The device of any of the clauses 1-28, wherein the waves comprise electromagnetic waves or fields having wavelengths in a range from ultraviolet to mid-infrared wavelengths.

32. The device of any of the clauses 1-31, wherein optical parametric oscillators (OPOs) are each an optical resonator with parametric nonlinearity.

33. The device of any of the clauses 1-32, wherein at least one of the free spectral range or one of its harmonics is matched to the pump repetition rate or its harmonics means NxFSR=MxFSR (N and M are non-zero positive integers) and any harmonic of FSR can be matched to any harmonic of RR, wherein the simplest case is M=N=1. FSR is free spectral range and RR is pump repetition rate.

34 The device of any of the clauses 1-33, wherein dispersion engineered comprises making a specific cross-section geometry to provide proper group-velocity dispersion (like FIG. 5 or FIG. 30b).

35. The device of any of the clauses 1-34, wherein the electro-optic comb source includes a modulator which can be realized by depositing metal on lithium niobate or on a thin layer of dielectric deposited on lithium niobate.

36. The device of any of the clauses 1-35, wherein the resonators comprise ring resonators.

### Method of Operation

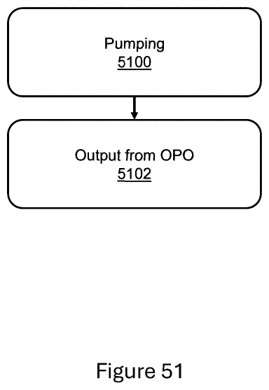

FIG. 51 illustrates a method of operating a device, comprising the following steps.

Block 5100 represents pumping one or more OPOs with a pump wave comprising pulses or a frequency comb with a pump repetition rate, wherein the OPOs each comprise one or a plurality of nonlinear sections 110, 3110 as part of a resonator 3112, 112 (comprising waveguide 113, 3113) or coupled to a resonator having a free spectral range, where at least one of the free spectral range or one of its harmonics (harmonics of the spectral range) is matched to (e.g., equal to, or within 10% of) at least one of the pump repetition rate or its harmonics.

Block 5102 represents extracting a portion of the waves (arrow 118 shows direction of extracted waves) generated by the OPO in response to the pump wave and/or a harmonic of the pump wave.

The method can be implemented using the device of any of the clauses 1-36.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A device, comprising:
a photonic integrated circuit comprising one or more OPOs each comprising:
an input configured to receive a pump wave comprising pulses or a frequency comb with a pump repetition rate,
one or a plurality of nonlinear sections as part of a resonator or coupled to a resonator having a free spectral range, where at least one of the free spectral range or one of its harmonics is matched to the pump repetition rate or its harmonics, and
one or a plurality of outputs configured to extract a portion of the waves generated by the OPO in response to the pump wave and/or the pump wave.

2. The device of claim 1, wherein each of the nonlinear sections are phase matched for one or a plurality of nonlinear optical processes including degenerate optical parametric amplification, non-degenerate optical parametric amplification, up-conversion of the waves in the OPO, down-conversion of the waves in the OPO, spectral broadening of the waves in the OPO.

3. The device of claim 2, wherein the phase matching is achieved through quasi-phase matching.

4. The device of claim 1, wherein the nonlinear section and/or other parts of the resonator is dispersion engineered to adjust the spectrum of one or a plurality of the waves generated in the OPO.

5. The device of claim 4, wherein the dispersion engineered OPO supports formation of temporal solitons.

6. The device of claim 1, wherein the photonic integrated circuit further comprises one or more actuators for modulating and/or adjusting one or a plurality of:
a phase matching condition of the nonlinear sections,
the center frequency of the portion of the wave comprising an output wave,
the carrier-envelope offset frequency of the output waves,
the free-spectral range of the resonator,
the spectral response of resonator.

7. The device of claim 6, where in the actuators comprise at least one of an electro-optic modulator, an electric heater, a thermos-optical heater, or a piezoelectric transducer.

8. The device of claim 1, comprising a plurality of OPOs, wherein each of the OPOs comprise the nonlinear sections with different phase matchings for different nonlinear processes.

9. The device of claim 8, wherein the photonic integrated circuit further comprises:
a switching circuit configured to selectively route the pump wave to different ones of the OPOs, so that the outputs of the OPOs, independently or in combination, comprise outputs ranging from ultraviolet to mid infrared wavelengths.

10. The device of claim 1, wherein the photonic integrated circuit comprises an integrated input coupler, and the output comprises an integrated output coupler, or the input coupler and the output coupler each independently comprise an adiabatic coupler, a directional coupler, a Y-junction, a multi-mode interferometer, or an inverse-designed coupler.

11. The device of claim 1, wherein the resonator comprises a spiral resonator or a resonator having a length of at least 10 centimeters.

12. The device of claim 1, wherein the output bandwidth is at least a factor of 2 broader than the input bandwidth of the pump input in hertz units.

13. The device of claim 1, wherein the photonic integrated circuit includes a sub-circuit for the pump, wherein the sub-circuit is configured to output the pump wave comprising the pulses or the frequency comb with the pump repetition rate.

14. The device of claim 13, wherein the sub-circuit comprises at least one of a mode-locked laser, an electro-optic frequency comb source, a Kerr frequency comb source, an amplitude modulator, or a phase modulator.

15. The device of claim 13, wherein the sub-circuit comprises one or more actuators operable to adjust at least one of the repetition rate, a carrier envelope offset, an intensity, or a wavelength of the pump wave.

16. The device of claim 1, wherein the pump pulses have lengths in a range of 1-100 picoseconds and the OPO generates pulses shorter than 1 picosecond.

17. The device of claim 1, wherein the OPO is inside an integrated laser cavity or the OPO includes a laser gain element.

18. The device of claim 1, wherein the pump pulses or frequency comb are created inside the resonator.

19. The device of claim 1, wherein the pump frequency comb does not constitute clear pulses in the time domain or comprises a continuous wave frequency modulated wave.

20. The device of claim 1, wherein the circuit comprises additional components at the output of the OPO including:
nonlinear components for wavelength conversion,
nonlinear components for spectral broadening,
Linear components such as filters and couplers,
actuators such as electro-optic modulators.

21. A computing system, metrology system, or communication system comprising the device of claim 1.
